(19) United States
(12) Patent Application Publication
(10) Pub. No.: US 2006/0170630 A1
(43) Pub. Date: Aug. 3, 2006

(54) Plasma display panel (PDP) and method of driving PDP

(76) Inventors: Min Hur, Suwon-si (KR); Jae-Yong Lim, Suwon-si (KR)

Correspondence Address: Robert E. Bushnell, Suite 300, 1522 K Street, N.W., Washington, DC, 20005, US

(21) Appl. No.: 11/297,456

(22) Filed: Dec. 9, 2005

(30) Foreign Application Priority Data
Feb. 1, 2005 (KR) 10-2005-0009044
Mar. 10, 2005 (KR) 10-2005-0020012

(51) Int. Cl. G09G 3/30

(52) U.S. Cl. 345/77

(57) ABSTRACT

A Plasma Display Panel (PDP) has an opposed discharge structure to reduce its discharge firing voltage and to enhance its luminescence efficiency. The PDP includes: a first substrate and a second substrate arranged to face each other with a space therebetween, the space between the first substrate and the second substrate being divided into a plurality of discharge cells; phosphor layers arranged in the plurality of discharge cells; first electrodes and second electrodes extending in a first direction between the first substrate and the second substrate and alternately disposed in parallel on both sides of respective discharge cells in a second direction intersecting the first direction and shared by adjacent discharge cells, the first electrodes and the second electrodes having floating portions extending toward the second substrate in a direction away from the first substrate and arranged to face one another in spaces corresponding to the respective discharge cells; and address electrodes extending in the second direction between the first substrate and the second substrate, the address electrodes having protruding portions that protrude between the floating portions of the first electrodes and the floating portions of the second electrodes.

### CLAIM OF PRIORITY

This application makes reference to, incorporates the same herein, and claims all benefits accruing under 35 U.S.C. § 119 from applications entitled PLASMA DISPLAY PANEL (PDP) AND METHOD OF DRIVING PDP, earlier filed in the Korean Intellectual Property Office on 1 Feb. 2005 and 10 Mar. 2005 and there duly assigned Ser. Nos. 10-2005-0009044 and 10-2005-0020012, respectively.

### BACKGROUND OF THE INVENTION

1. Field of the Invention

The present invention relates to a Plasma Display Panel (PDP) and a method of driving the PDP. More particularly, the present invention relates to a PDP that can reduce a discharge firing voltage and enhance luminescence efficiency, and to a method of driving a PDP.

2. Description of the Related Art

Generally, a Plasma Display Panel (PDP) has a three-electrode surface-discharge structure. The PDP having the three-electrode surface-discharge structure includes front and rear substrates, with a discharge gas sealed between the substrates.

The front substrate has sustain electrodes and scan electrodes that extend in one direction on the inner surface thereof. The rear substrate is spaced apart from the inner surface of the front substrate and has address electrodes that extend in a direction intersecting the sustain electrodes and the scan electrodes.

In this PDP, whether or not a discharge is generated is determined by an address discharge between the independently controlled sustain electrodes and address electrodes. Images are realized by a sustain discharge by the sustain electrodes and the scan electrodes disposed on the inner surface of the front substrate.

The PDP generates visible light by using a glow discharge. After the glow discharge has been generated, visible light reaches human eyes through several steps.

That is, if the glow discharge has been generated, gas has been excited by the collision of electrons against the gas and vacuum ultraviolet rays are then generated by the gas excited in such a manner. The vacuum ultraviolet rays collide against phosphors in discharge cells, such that visible light is generated and reaches human eyes through the transparent front substrate.

While passing through such steps, considerable input energy applied to a cathode and an anode is lost.

The glow discharge is generated by supplying a voltage higher than a discharge firing voltage between the electrodes. That is, in order to fire the glow discharge, a considerably high voltage is required.

Once the discharge has been generated, the voltage distribution between the cathode and the anode is distorted due to a space charge effect caused by dielectric layers in the vicinities of the cathode and the anode.

That is, a cathode sheath region, an anode sheath region, and a positive column region are formed between the electrodes.

The cathode sheath region is a region in the vicinity of the cathode, in which most of the voltage supplied between two electrodes is consumed. The anode sheath region is a region in the vicinity of the anode, in which some of the voltage is consumed. The positive column region is a region between the cathode sheath region and the anode sheath region, in which almost no voltage is consumed.

The electron heating efficiency of the cathode sheath region depends on the secondary electron coefficient of an MgO protective film that is formed on the surface of the dielectric layer. In the positive column region, most of the input energy is consumed by electron heating.

The vacuum ultraviolet rays are generated when xenon (Xe) gas is changed from an excitation state to a ground state. The excitation state of Xe gas is generated by collisions between Xe gas and electrons.

In order to increase the ratio of visible light to the input energy (that is, luminescence efficiency), the collisions between Xe gas and electrons must be increased. Furthermore, in order to increase these collisions, the electron heating efficiency must be increased.

In the cathode sheath region, most of the input energy is consumed, but the electron heating efficiency is low. In the positive column region, consumption of the input energy is low and the electron heating efficiency is high. Accordingly, high luminescence efficiency can be obtained by increasing the positive column region (discharge gap).

The change of the ratio E/n between the electric field E across the discharge gap (positive column region) and the gas density n, and the ratio of electron consumption to the overall electrons have been studied.

It is known that the ratio of electron consumption is increased in an order of xenon excitation Xe*, xenon ions Xe⁺, neon excitation Ne*, and neon ions Ne⁺ at the same ratio E/n.

Furthermore, it is known that, at the same ratio E/n, the higher the partial pressure of Xe is, the lower the electron energy is.

That is, if the electron energy is decreased, the partial pressure of Xe is increased. In this case, from electron consumption for xenon excitation Xe*, xenon ions Xe⁺, neon excitation Ne*, and neon ions Ne⁺, the ratio of electron consumption for the excitation of Xe becomes higher. Accordingly, the luminescence efficiency is enhanced.

As described above, the increase of the positive column region results in the increase of the electron heating efficiency. Furthermore, the increase of the partial pressure of Xe results in the increase of the electron heating efficiency of electrons consumption for the excitation of Xe from the electrons. Accordingly, both result in the increase of the electron heating efficiency, thereby enhancing the luminescence efficiency.

However, the increase of the positive column region or the increase of the partial pressure of Xe results in the increase of the discharge firing voltage, which causes the manufacturing costs of the PDP to be increased.

Accordingly, the increase of the positive column region and the increase of the partial pressure of Xe must be achieved with a low discharge firing voltage, thereby enhancing the luminescence efficiency.

It is known that, when the distance of the discharge gap and the partial pressure of Xe are the same, the discharge firing voltage required for the opposed discharge structure is lower than the discharge firing voltage required for the surface discharge structure.

### SUMMARY OF THE INVENTION

It is an object of the present invention to provide a Plasma Display Panel (PDP) having an opposed discharge structure to reduce its discharge firing voltage and to enhance its luminescence efficiency, and a method of driving the PDP.

It is another object of the present invention to provide a PDP which can reduce a discharge firing voltage and reduce a reset period and an address period, thereby enhancing the power of gray-scale representation, and a method of driving the PDP.

According to one aspect of the present invention, a Plasma Display Panel (PDP) is provided including: a first substrate and a second substrate arranged to face each other with a space therebetween, the space between the first substrate and the second substrate being divided into a plurality of discharge cells; phosphor layers arranged in the plurality of discharge cells; first electrodes and second electrodes extending in a first direction between the first substrate and the second substrate and alternately disposed in parallel on both sides of respective discharge cells in a second direction intersecting the first direction and shared by adjacent discharge cells, the first electrodes and the second electrodes having floating portions extending toward the second substrate in a direction away from the first substrate and arranged to face one another in spaces corresponding to the respective discharge cells; and address electrodes extending in the second direction between the first substrate and the second substrate, the address electrodes having protruding portions that protrude between the floating portions of the first electrodes and the floating portions of the second electrodes.

The PDP preferably further includes: a first barrier rib layer arranged adjacent to the first substrate to define a plurality of discharge spaces; and a second barrier rib layer arranged adjacent to the second substrate to define discharge spaces facing the respective discharge spaces defined by the first barrier rib layer; the respective discharge cells are divided by pairs of discharge spaces facing each other.

The address electrodes, the first electrodes, and the second electrodes are preferably arranged between the first barrier rib layer and the second barrier rib layer.

The protruding portions are preferably plurally arranged along the second direction in the respective discharge cells.

The address electrodes, the protruding portions of the address electrodes, and the floating portions of the first electrodes and the second electrodes corresponding to the protruding portions are preferably arranged adjacent to the first substrate; the first electrodes and the second electrodes are arranged adjacent to the second substrate; and the protruding portions of the address electrodes and the floating portions of the first electrodes and the second electrodes are preferably arranged on a same line in a direction parallel to the planes of the substrates.

The protruding portions and the floating portions preferably have the same thickness in a direction perpendicular to the planes of the substrates.

The address electrodes, the protruding portions of the address electrodes, and the floating portions of the first electrodes and the second electrodes corresponding to the protruding portions are preferably arranged adjacent to the second substrate; the first electrodes and the second electrodes are preferably arranged adjacent to the first substrate, and the protruding portions of the address electrodes and the floating portions of the first electrodes and the second electrodes are preferably arranged on a same line in a direction parallel to the planes of the substrates.

The protruding portions and the floating portions preferably have the same thickness in a direction perpendicular to the planes of the substrates.

A thickness of each of the address electrodes is preferably less than a height of each of the first electrodes in a direction perpendicular to the planes of the substrates. A thickness of each of the address electrodes is preferably less than a height of each of the second electrodes in a direction perpendicular to the planes of the substrates.

A height of each of the first electrodes is preferably greater than a thickness of each of the floating portions of the first electrodes in a direction perpendicular to the planes of the substrates. A height of each of the second electrodes is preferably greater than a thickness of each of the floating portions of the second electrodes in a direction perpendicular to the planes of the substrates.

The first electrodes and the second electrodes preferably have structures in which a vertical length is greater than a horizontal length in a direction perpendicular to the planes of the substrates.

A horizontal length of each of the floating portions of the first electrodes and the second electrodes is preferably greater than a horizontal length of each of the first electrodes and the second electrodes in a direction perpendicular to the planes of the substrates.

The first electrodes and the second electrodes preferably include a metal. The first electrodes, the second electrodes, and the address electrodes are preferably covered with a dielectric layer to include an insulated structure.

The dielectric layer preferably includes a black dielectric material. The dielectric layer preferably includes a black dielectric material layer arranged on the second substrate. The dielectric layer is preferably covered with a protective film.

The first barrier rib layer has first barrier rib members arranged in a direction parallel to the address electrodes and second barrier rib members arranged to intersect the first barrier rib members; and the second barrier rib layer preferably has third barrier rib members arranged to correspond to the first barrier rib members and fourth barrier rib members arranged to intersect the third barrier rib members.

The phosphor layers preferably include first phosphor layers arranged on the first substrate of the respective discharge cells and second phosphor layers arranged on the second substrate of the respective discharge cells.

The first electrodes that supply sustain pulses in a sustain period, the floating portions of the first electrodes, the second electrodes that supply the sustain pulses in the sustain period and supply scan pulses in a scan period, and the floating portions of the second electrodes are preferably alternately arranged on both sides of the respective discharge cells in the second direction and shared by the adjacent discharge cells; and the first electrodes, the floating portions of the first electrodes, the second electrodes, and the floating portions of the second electrodes corresponding to adjacent discharge cells in the second direction are preferably arranged in the same order.

According to another aspect of the present invention, a method of driving a Plasma Display Panel (PDP) includes: alternately arranging first electrodes and second electrodes in parallel on both sides of respective discharge cells of the PDP and shared by adjacent discharge cells; arranging floating portions of the first electrodes, floating portions of the second electrodes, and first address electrodes and second address electrodes of the PDP to intersect the first electrodes and the second electrodes and to correspond to the respective discharge cells in parallel and arranging protruding portions between the floating portions; supplying a scan pulse to at least a portion of the corresponding second electrode shared by adjacent discharge cells in an address period; and addressing adjacent discharge cells, to which the scan pulse has been supplied in the address period.

Addressing adjacent discharge cells preferably includes addressing one of the adjacent discharge cells by the corresponding first address electrode. Addressing adjacent discharge cells preferably includes addressing the other of the adjacent discharge cells by the corresponding second address electrode.

According to yet another aspect of the present invention, a Plasma Display Panel (PDP) is provided including: a first substrate and a second substrate arranged to face each other with a space therebetween, the space between the first substrate and the second substrate being divided into a plurality of discharge cells; first electrodes and second electrodes extending in a first direction between the first substrate and the second substrate and alternately arranged in parallel on both sides of the respective discharge cells in a second direction intersecting the first direction and shared by adjacent discharge cells, the first electrodes and the second electrodes being divided into at least two portions in directions toward the first substrate and the second substrate to face each other in a space; and first address electrodes and second address electrodes extending in the second direction between the first substrate and the second substrate, the first address electrodes and the second address electrodes having protruding portions alternately protruding inside the discharge cells arranged along the second direction.

The first address electrodes are preferably arranged on the first substrate and the second address electrodes are arranged on the second substrate with the first electrodes and the second electrodes therebetween. The first address electrodes and the second address electrodes are preferably arranged on the same side of the discharge cells in the first direction. The first address electrodes and the second address electrodes are preferably respectively arranged on the first substrate and the second substrate.

The protruding portions of the first address electrodes and the protruding portions of the second address electrodes preferably protrude toward centers of the respective discharge cells on the same side of the discharge cells. The first address electrodes and the second address electrodes are preferably arranged on both sides of the respective discharge cells in the first direction.

The protruding portions of the first address electrodes and the protruding portions of the second address electrodes preferably protrude toward centers of the respective discharge cells on both sides of the respective discharge cells. The first address electrodes and the second address electrodes preferably include a metal. The first electrodes and the second electrodes preferably have floating portions separated in a direction perpendicular to planes of the substrates.

The first electrodes and the second electrodes preferably have first floating portions separated on the first substrate to correspond to the discharge cells and second floating portions separated on the second substrate to correspond to the first floating portions.

The protruding portions of the first address electrodes are preferably arranged between the first floating portions of the first electrodes and the second floating portions of the second electrodes; and the protruding portions of the second address electrodes are preferably arranged between the second floating portions of the first electrodes and the second floating portions of the second electrodes.

The PDP preferably further includes: a first barrier rib layer arranged adjacent to the first substrate to define a plurality of discharge spaces; and a second barrier rib layer arranged adjacent to the second substrate to define discharge spaces facing the respective discharge spaces defined by the first barrier rib layer; the respective discharge cells are divided by the pairs of discharge spaces facing each other; the first electrodes and the second electrodes are arranged between the first barrier rib layer and the second barrier rib layer; the first address electrodes, the protruding portions of the first address electrodes, and the first floating portions of the first electrodes and the second electrodes corresponding to the protruding portions are arranged adjacent to the first substrate; and the second address electrodes, the protruding portions of the second address electrodes, and the second floating portions of the first electrodes and the second electrodes corresponding to the protruding portions are arranged adjacent to the second substrate.

The protruding portions of the first address electrodes and the first floating portions of the first electrodes and the second electrodes corresponding to the protruding portions are preferably arranged on a same line in a direction parallel to planes of the substrates; and the protruding portions of the second address electrodes and the second floating portions of the first electrodes and the second electrodes corresponding to the protruding portions are preferably arranged on a same line in a direction parallel to the planes of the substrates.

The protruding portions of the first address electrodes and the first floating portions of the first electrodes and the second electrodes corresponding to the protruding portions preferably have the same thickness in a direction perpendicular to planes of the substrates; and the protruding portions of the second address electrodes and the second floating portions of the first electrodes and the second electrodes corresponding to the protruding portions preferably have the same thickness in a direction perpendicular to the planes of the substrates.

The first electrodes and the second electrodes preferably include a metal. The first electrodes, the second electrodes, the first address electrodes, and the second address electrodes are preferably covered with a dielectric layer to include an insulated structure.

The dielectric layer preferably has a protective film arranged on the outer surface thereof.

Each discharge space defined by the second barrier rib layer preferably has a volume greater than that of each discharge space defined by the first barrier rib layer.

According to still another aspect of the present invention, a method of driving a Plasma Display Panel (PDP) includes: alternately arranging first electrodes and second electrodes of the PDP in parallel on both sides of respective discharge cells and shared by adjacent discharge cells and divided into at least two portions on both sides of respective discharge cells; arranging floating portions of the first electrodes, and first address electrodes and second address electrodes of the PDP to intersect the first electrodes and the second electrodes and to correspond to the respective discharge cells in parallel and having protruding portions alternately protruding in the discharge cells arranged in the extended direction thereof: supplying a scan pulse to at least a portion of the corresponding second electrode shared by adjacent discharge cells in an address period; and addressing adjacent discharge cells, to which the scan pulse has been supplied in an address period.

Addressing adjacent discharge cells preferably includes addressing one of the adjacent discharge cells by the corresponding first address electrode. Addressing adjacent discharge cells preferably includes addressing the other of the adjacent discharge cells by the corresponding second address electrode.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial exploded perspective view of a PDP according to a first embodiment of the present invention;

FIG. 2 is a plan view of structures of electrodes and discharge cells in the PDP according to the first embodiment of the present invention;

FIG. 3 is a cross-sectional view taken along the line III-III of FIG. 1 when the PDP is assembled;

FIG. 4 is a cross-sectional view taken along the line IV-IV of FIG. 1 when the PDP is assembled;

FIG. 5 is a perspective view of structures of electrodes in the PDP according to the first embodiment of the present invention;

FIG. 6 is a cross-sectional view of a sustain discharge between a sustain electrode and a scan electrode in the PDP according to the first embodiment of the present invention;

FIG. 7 is a cross-sectional view of a sustain discharge between a sustain electrode and a scan electrode in the PDP according to the first embodiment of the present invention;

FIG. 8 is a cross-sectional view of a PDP according to a second embodiment of the present invention;

FIG. 9 is a cross-sectional view of a PDP according to a third embodiment of the present invention;

FIG. 10 is a cross-sectional view of a PDP according to a fourth embodiment of the present invention;

FIG. 11 is a perspective view of structures of electrodes in a PDP according to a fifth embodiment of the present invention;

FIG. 12 is a schematic view of the relationship of first and second address electrodes and respective drivers in the PDP according to the fifth embodiment of the present invention;

FIG. 13 are driving waveforms in a method of driving a PDP according to the fifth embodiment of the present invention;

FIG. 14 is a partially exploded perspective view of a PDP according to a sixth embodiment of the present invention;

FIG. 15 is a plan view of structures of electrodes and discharge cells in the PDP according to the sixth embodiment of the present invention;

FIG. 16 is a cross-sectional view taken along the line XVI-XVI of FIG. 14 when the PDP is assembled;

FIG. 17 is a perspective view of structures of electrodes in the PDP according to the sixth embodiment of the present invention;

FIG. 18 is a schematic view of the relationship of first and second address electrodes and respective drivers in the PDP according to the sixth embodiment of the present invention;

FIG. 19 are driving waveforms in a method of driving a PDP according to the sixth embodiment of the present invention;

FIG. 20 is a plan view of structures of electrodes and discharge cells in a PDP according to a seventh embodiment of the present invention;

FIG. 21 is a cross-sectional view of a PDP according to an eighth embodiment of the present invention;

FIG. 22 is a cross-sectional view of a PDP according to a ninth embodiment of the present invention;

FIG. 23 is a cross-sectional view of a PDP according to a tenth embodiment of the present invention; and

FIG. 24 is a cross-sectional view of a PDP according to an eleventh embodiment of the present invention.

### DETAILED DESCRIPTION OF THE INVENTION

Hereinafter, embodiments of the present invention are described in detail with reference to the accompanying drawings such that the present invention can be carried out by a person of ordinary skill in the technical field of the present invention. However, the present invention is not limited to these embodiments, and various modifications can be implemented. Moreover, in the drawings, for clear explanation, portions having no relation to the present invention have been omitted. Furthermore, the same parts over the entire specification are represented by the same reference numerals.

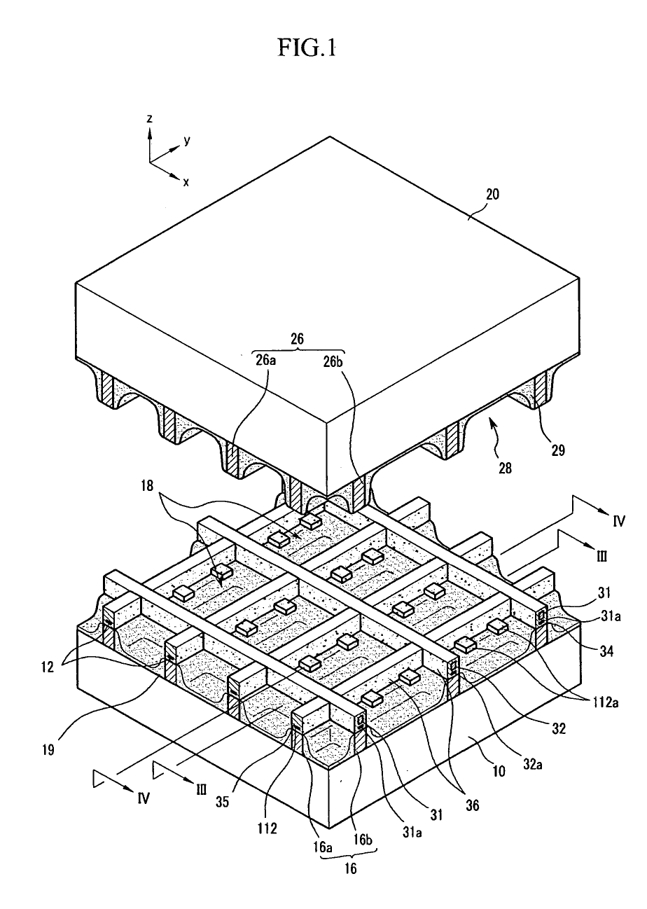

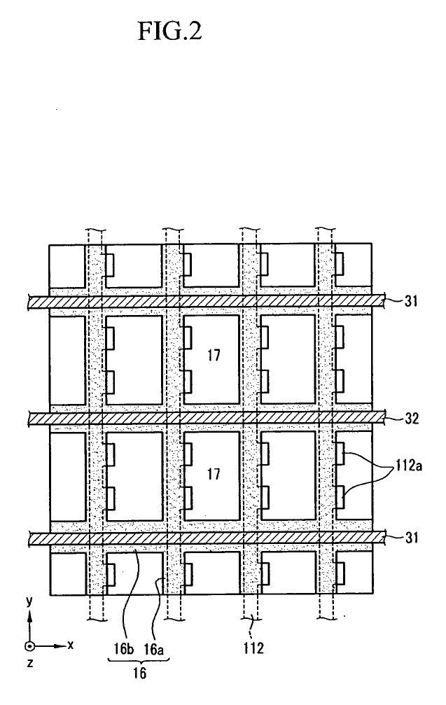

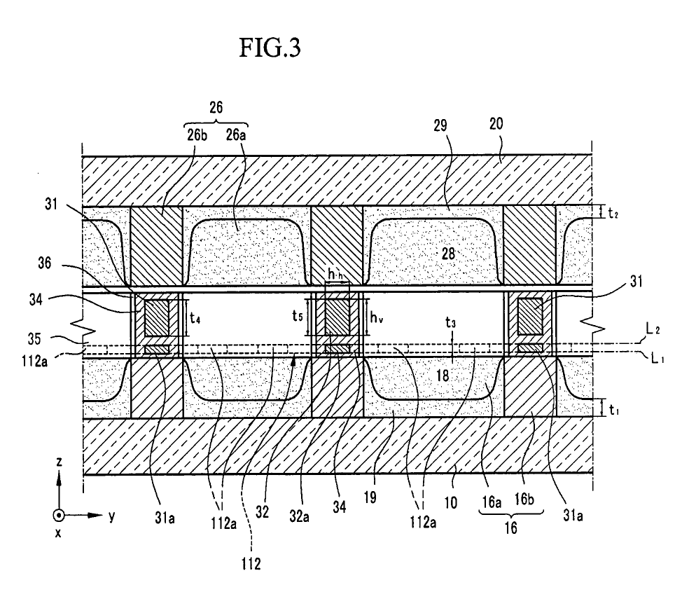

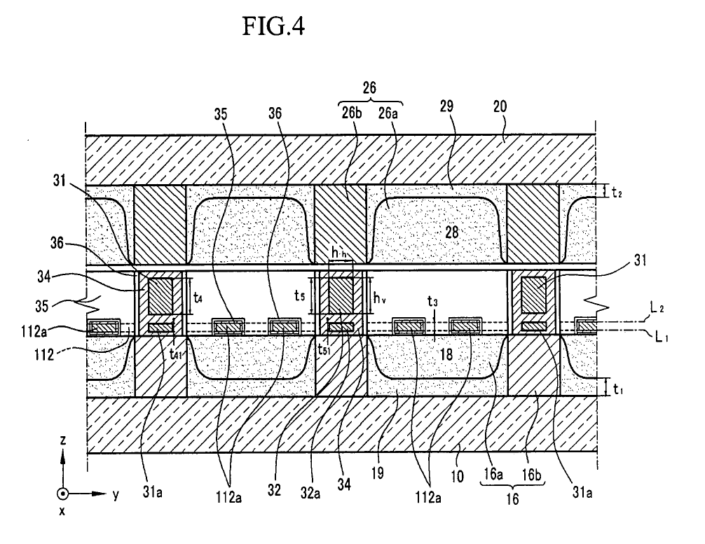

FIG. 1 is a partially exploded perspective view of a PDP according to a first embodiment of the present invention. FIG. 2 is a plan view of structures of electrodes and discharge cells in the PDP according to the first embodiment of the present invention. FIG. 3 is a cross-sectional view taken along the line III-III of FIG. 1 when the PDP is assembled. FIG. 4 is a cross-sectional view taken along the line IV-IV of FIG. 1 when the PDP is assembled.

Referring to FIGS. 1 to 4, the PDP according to the first embodiment of the present invention includes a first substrate 10 (hereinafter, referred to as a “rear substrate”) and a second substrate 20 (hereinafter, referred to as a “front substrate”) that face each other with a gap therebetween, and a first barrier rib layer 16 (hereinafter, referred to as a “rear-substrate-side barrier rib”) and a second barrier rib layer 26 (hereinafter, referred to as a “front-substrate-side barrier rib”) that are disposed between the rear substrate 10 and the front substrate 20 to form discharge cells 17.

The rear-substrate-side barrier rib 16 and the front-substrate-side barrier rib 26 respectively divide a plurality of discharge spaces 18 and 28. The discharge spaces 18 and 28 on both sides form one discharge cell 17.

In the discharge cells 18, phosphor layers 19 and 29 are formed so as to absorb vacuum ultraviolet rays and to emit visible light. Furthermore, a discharge gas (for example, a mixed gas including xenon (Xe), neon (Ne), and the like) is filled into the discharge cells 18 so as to generate the vacuum ultraviolet rays by a plasma discharge.

The rear-substrate-side barrier rib 16 is formed to protrude toward the front substrate 20 from the rear substrate 10, and the front-substrate-side barrier rib 26 is formed to protrude toward the rear substrate 10 from the front substrate 20 so as to correspond the rear-substrate-side barrier rib 16.

The rear-substrate-side barrier rib 16 divides a plurality of discharge spaces 18 near the rear substrate 10 so as to form the discharge cells 17 on the rear substrate 10. The front-substrate-side barrier rib 26 divides a plurality of discharge spaces 28 near the front substrate 20 so as to form the discharge cells 17 on the front substrate 20. The discharge spaces 18 and 28 facing each other on both sides substantially form one discharge cell 17.

In the present invention, as long as specified indications on the discharge cells 17 are not given, the discharge cells 17 mean one discharge space that is formed by two discharge spaces 18 and 28.

It is preferable that the discharge spaces 28 formed by the front-substrate-side barrier rib 26, that is, the discharge cells 17 on the front substrate 20, have volumes larger those that of the discharge spaces 18 formed by the rear-substrate-side barrier rib 16, that is, the discharge cells 17 on the rear substrate 10. In this case, transmittance of visible light generated in the discharge cells 18 passing through the front substrate 20 can be enhanced.

The rear-substrate-side barrier rib 16 and the front-substrate-side barrier rib 26 can form the discharge cells 17 to have various shapes, such as rectangular shapes or hexagonal shapes, in a plane direction of the substrates 10 and 20 (xy plane). In the present embodiment, the discharge cells 17 having rectangular shapes are given as an example. Hereinafter, the rectangular discharge cells 17 are referred to.

The rear-substrate-side barrier rib 16 is formed on the rear substrate 10 and includes first barrier rib members 16a and second barrier rib members 16b. The first barrier rib members 16a are disposed to extend in a y-axis direction (second direction). The second barrier rib members 16b are disposed to extend in an x-axis direction intersecting the first barrier rib members 16a.

Accordingly, the first-barrier rib members 16a and the second barrier rib members 16b form the discharge cells 17 on the rear substrate 10 as independent discharge spaces 18.

The front-substrate-side barrier rib 26 is formed on the front substrate 20 and includes third barrier rib members 26a and fourth barrier rib members 26b. The third barrier rib members 26a are formed to protrude toward the rear substrate 10 to have shapes corresponding to the first barrier rib members 16a. The fourth barrier rib members 26b are formed to protrude toward the rear substrate 10 to have shapes corresponding to the second barrier rib members 16b.

Accordingly, the third barrier rib members 26a and the fourth barrier rib members 26b extend in directions intersecting each other and form the discharge cells 17 on the front substrate 20 as independent discharge spaces 28. The discharge spaces 28 correspond to the discharge spaces 18 on the rear substrate 10.

The phosphor layers 19 and 29 are formed in the discharge cells 17 that are divided by the rear-substrate-side barrier rib 16 and the front-substrate-side barrier rib 26.

That is, the phosphor layers 19 and 29 include first phosphor layers 19 that are formed in the discharge cells 17 on the rear substrate 10 and second phosphor layers 29 that are formed in the discharge cells 17 on the front substrate 20.

The first phosphor layers 19 and the second phosphor layers 29 generate visible light of the same color due to vacuum ultraviolet rays caused by a gas discharge.

The first phosphor layers 19 and the second phosphor layers 29 generate visible light from both the discharge spaces 18 and 28, which substantially form one discharge cell 17, such that luminescence efficiency can be enhanced.

The first phosphor layer 19 is formed on the inner surfaces of the first barrier rib member 16a and the second barrier rib member 16b and the surface of the rear substrate 10 in the discharge cell 17.

Furthermore, the second phosphor layer 29 is formed on the inner surfaces of the third barrier rib member 26a and the fourth barrier rib member 26b and the surface of the front substrate 20 in the discharge cell 17.

On the other hand, as shown in the drawings, the first phosphor layers 19 can be formed by forming the rear-substrate-side barrier rib 16 on the rear substrate I 0 and by coating phosphors on the rear-substrate-side barrier rib 16.

Similarly, as shown in the drawings, the second phosphor layers 29 can be formed by forming the front-substrate-side barrier rib 26 on the front substrate 20 and by coating phosphors on the front-substrate-side barrier rib 26.

In addition, the first phosphor layers 19 can be formed by etching the rear substrate 10 to correspond to the shapes of the discharge cells 17 and by coating phosphors on the etched surface.

Furthermore, the second phosphor layers 29 can be formed by etching the front substrate 20 to correspond to the shapes of the discharge cells 17 and by coating phosphors on the etched surface.

In this case, the rear substrate 10 and the rear-substrate-side barrier rib 16 are made of the same material, and the front substrate 20 and the front-substrate-side barrier rib 26 are made of the same material.

By using such an etching method, manufacturing costs can be reduced, as compared with the method in which the rear-substrate-side barrier rib 16 and the front-substrate-side barrier rib 26 are formed separately from the rear substrate 10 and the front substrate 20.

After a sustain discharge, the first phosphor layers 19 absorb vacuum ultraviolet rays in the discharge spaces 18 and generate visible light toward the front substrate 20. Furthermore, the second phosphor layers 29 absorb vacuum ultraviolet rays in the discharge spaces 28 and generate visible light toward the front substrate 20.

Therefore, the first phosphor layers 19 are made of reflective phosphors that reflect visible light, and the second phosphor layers 29 are made of transmissive phosphors that transmit visible light.

In order to enhance luminescence efficiency by visible light passing through the front substrate 20, the thickness t1 of each of the first phosphor layers 19 formed on the rear substrate 110 is preferably larger than the thickness t2 of each of the second phosphor layers 29 formed on the front substrate 20 (t1>t2). That is, the particle size of the phosphor powder forming the first phosphor layers 19 is larger than the particle size of the phosphor powder forming the second phosphor layers 29. Accordingly, the loss of vacuum ultraviolet rays can be minimized and thus luminescence efficiency can be enhanced.

The vacuum ultraviolet rays, which collide against the first phosphor layers 19 and the second phosphor layers 29, are generated by a plasma discharge to realize images. For the plasma discharge, address electrodes 112, first electrodes 31 (hereinafter, referred to as “sustain electrodes”), and second electrodes 32 (hereinafter, referred to as “scan electrodes”) are provided between the rear substrate 10 and the front substrate 20 so as to correspond to the respective discharge cells 17.

As shown in FIG. 2, the address electrodes 112 are formed to extend in a y-axis direction (second direction) and have protruding portions 112a that protrude in an x-axis direction (first direction). That is, the address electrodes 112 are disposed in parallel at gaps corresponding to the discharge cells 17 in the x-axis direction so as to correspond to the first barrier rib members 16a.

The sustain electrodes 31 and the scan electrodes 32 are disposed in an opposed discharge structure with the discharge cells 17 therebetween and are formed to extend in parallel in the x-axis direction. The sustain electrodes 31 and the scan electrodes 32 are alternately 15 disposed on both sides of respective discharge cells 17 in the y-axis direction so as to be shared by adjacent discharge cells 17. The sustain electrodes 31 and the scan electrodes 32 have floating portions 31a and 32a that are formed in pieces corresponding to the discharge cells 17.

The protruding portions 112a of the address electrodes 112 are disposed between the floating portions 31a of the sustain electrodes 31 and the floating portions 32a of the scan electrodes 32.

Therefore, the sustain electrodes 31 and the scan electrodes 32 are involved in the sustain discharge between two adjacent discharge cells 17.

Such a PDP can use two discharge cells 17 formed on both sides of the scan electrode 32 as a sub-pixel that emits one light component of red (R), green (G), or blue (B). This structure is suitable for a PDP having a large screen.

Furthermore, in such a PDP, the sustain electrodes 31 and the scan electrodes 32 are divided into even-numbered rows and odd-numbered rows. In this case, at the time of the sustain discharge of the even-numbered rows, the sustain electrodes 31 and the scan electrodes 32 of the even-numbered rows are supplied with sustain pulses. Furthermore, at the time of the sustain discharge of the odd-numbered rows, the sustain electrodes 31 and the scan electrodes 32 of the odd-numbered rows are supplied with the sustain pulses. As a result, images can be displayed. This structure is suitable for a high-definition PDP.

As shown in FIGS. 3 to 5, the address electrodes 112 are disposed between the rear-substrate-side barrier rib 16 and the front-substrate-side barrier rib 26 and are formed to extend in the y-axis direction (second direction) with respect to z-axis directions of the rear substrate 10 and the front substrate 20.

That is, the address electrodes 112 are formed to extend between the first barrier rib members 16a and the third barrier rib members 26a along a direction (y-axis direction) in parallel therewith. Furthermore, the address electrodes 112 are disposed in parallel at gaps corresponding to the discharge cells 17 in the x-axis direction.

The protruding portions 112a of the address electrodes 112 protrude inside the discharge cells 17 between the floating portions 31a of the sustain electrodes 31 and the floating portions 32a of the scan electrodes 32. The protruding portions 112a can be plurally disposed in the respective discharge cells 17. In this case, the protruding portions 112a and the floating portions 31 a and 32a are disposed in the discharge spaces 18 near the rear substrate 10 from both discharge spaces 18 and 28 of the discharge cells 17.

Therefore, the floating portion 32a of the sustain electrode 32, which is shared by adjacent discharge cells 17, corresponds to the protruding portions 112a of the address electrodes 112 on both sides thereof. If a sustain pulse is supplied to the sustain electrode 32 and an address pulse is supplied to the address electrode 112, then an address discharge is generated in adjacent discharge cells 17.

Furthermore, the protruding portion 112a supplies the address pulse, which is supplied to the address electrode 112, to adjacent discharge cells 17. For this reason, a discharge gap to the floating portion 32a of the scan electrode 32 in the discharge cell 17 is formed as a short gap, such that an address discharge voltage can be further reduced.

In the present embodiment, the address electrodes 112 are provided between the first barrier rib members 16a and the third barrier rib members 26a in the z-axis direction between adjacent discharge cells 17 in the x-axis direction. Therefore, the address electrodes can serve as a reference for dividing adjacent discharge cells 17 in the x-axis direction.

The protruding portions 112a are plurally formed in the respective discharge cells 17, and, at the time of the address discharge, perform triggering between the address electrodes 112 and the floating portions 32a of the scan electrodes 32, which enables the address discharge with a low voltage.

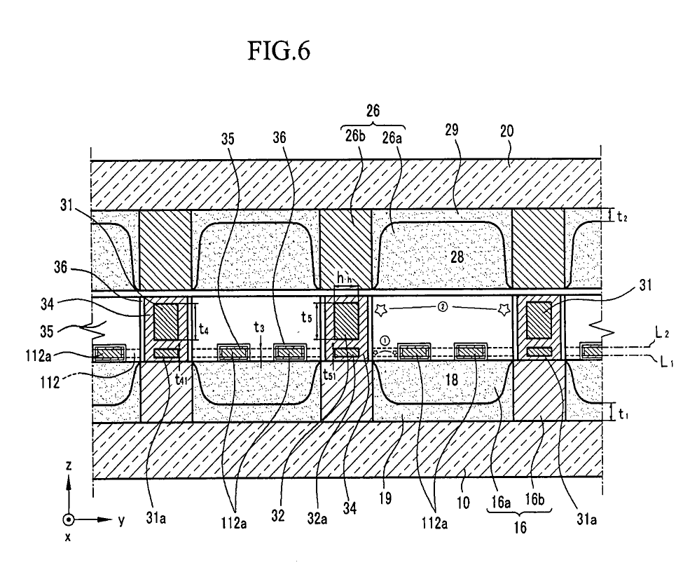

FIG. 6 shows that a discharge spot is increased from \textcircled{1} to \textcircled{2} through triggering of the protruding portions 112a and the floating portion 32a when the sustain pulse is supplied, such that the sustain discharge is generated.

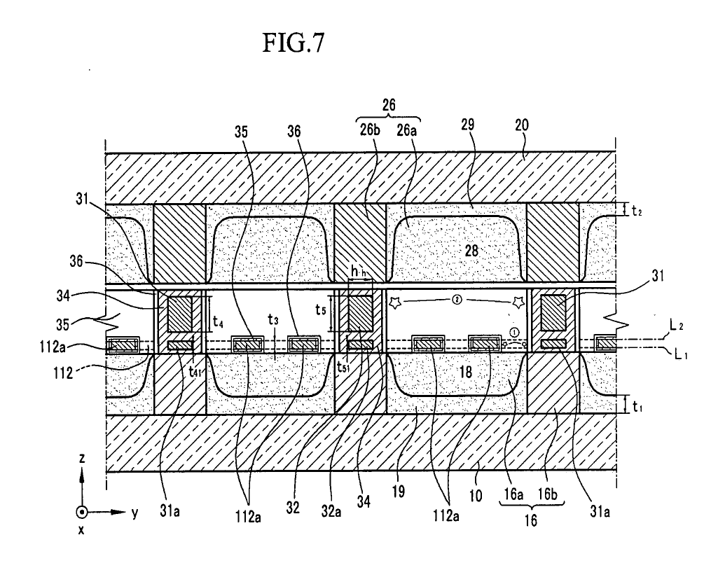

FIG. 7 shows that a discharge spot is increased from \textcircled{1} to \textcircled{2} through triggering of the protruding portions 112a and the floating portion 31a when the sustain pulse is supplied to the sustain electrode 31, such that the sustain discharge is generated.

The floating portions 31 a and 32a maintain floating states from the sustain electrode 31 and the scan electrode 32, and thus external voltages are supplied to the sustain electrode 31 and the scan electrode 32. For this reason, the voltages supplied to the sustain electrode 31 and the scan electrode 32 are higher than the voltages formed on the floating portions 31a and 32a.

Therefore, a trigger discharge is generated with a low voltage supplied to the floating portions 31 a and 32a and a strong sustain discharge is generated with a high voltage supplied to the sustain electrode 31 and the scan electrode 32, thereby enhancing luminescence efficiency.

Furthermore, the sustain electrodes 31 and the scan electrodes 32 are disposed between the rear-substrate-side barrier rib 16 and the front-substrate-side barrier rib 26 and are formed to extend in the x-axis direction with respect to the z-axis directions of the rear substrate 10 and the front substrate 20. The sustain electrodes 31 and the scan electrodes 32 are electrically isolated from the address electrodes 112.

That is, the sustain electrodes 31 and the scan electrodes 32 are formed to extend in the x-axis direction between the second barrier rib members 16b and the fourth barrier rib members 26b in parallel therewith and are alternately disposed so as to be shared by adjacent discharge cells 17.

In the present embodiment, the sustain electrodes 31 and the scan electrodes 32 are alternately disposed with respect to adjacent discharge cells 17 and are provided between the second barrier rib members 16b and the fourth barrier rib members 26b. Therefore, the sustain electrodes 31 and the scan electrodes 32 can serve as a reference for dividing adjacent discharge cells 17 in the y-axis direction.

The scan electrodes 32 are involved in the address discharge together with the address electrodes 112 in the address period, and serve to select the discharge cells 17 to be turned on. Furthermore, the sustain electrodes 31 and the scan electrodes 32 are involved in the sustain discharge in the sustain period and serve to display a screen.

That is, the sustain electrode 31 is supplied with the sustain pulse in the sustain period, and the scan electrodes 32 is supplied with the sustain pulse in the sustain period and the scan pulse in the address period. However, the respective electrodes can perform different functions in accordance with the signal voltages supplied thereto, and thus the first embodiment does not need to be limited to the above-described configuration.

The sustain electrodes 31 and the scan electrodes 32 are provided between both substrates 10 and 20 so as to divide one discharge cell 17 into both sides (in the z-axis direction) and to form an opposed discharge structure. Therefore, a discharge firing voltage can be reduced and luminescence efficiency can be enhanced.

Furthermore, in order to induce the opposed discharge over a wider area, the sustain electrodes 31 and the scan electrodes 32 can have cross-sectional structures, in which a vertical length hᵥ is longer than a horizontal length hₕ, in a cross-sectional view in a direction perpendicular to the rear substrate 10 and the front substrate 20 with respect to the respective discharge cells 17.

The opposed discharge generated over the wide area in such a manner generates strong vacuum ultraviolet rays. The strong vacuum ultraviolet rays collide against the first and second phosphor layers 19 and 29 over the wide area inside the discharge cells 17, such that the resultant amount of visible light is increased.

Furthermore, between the rear-substrate-side barrier rib 16 and the front-substrate-side barrier rib 26, the address electrodes 112, the protruding portions 112a of the address electrodes 112, and the floating portions 31a and 32a of the sustain electrodes 31 and the scan electrodes 32 corresponding to the protruding portions 112a are disposed adjacent to the rear substrate 10. The sustain electrodes 31 and the scan electrodes 32 are disposed adjacent to the front substrate 20.

The protruding portions 112a of the address electrodes 112 and the floating portions 31a and 32a of the sustain electrodes 31 and the scan electrodes 32 are formed on the same line (L1 to L2) in a direction parallel to the plane direction of the substrates 10 and 20.

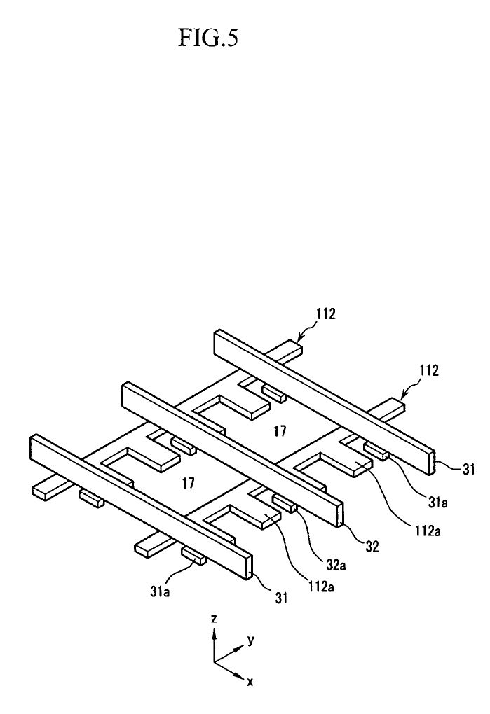

For this reason, the sustain electrodes 31, the scan electrodes 32, and the floating portions 31a and 32a of the sustain electrodes 31 and the scan electrodes 32 do not interfere with the address electrodes 112 and the protruding portions 112a thereof that are disposed in a direction intersecting them, and maintain the states shown in FIG. 5.

In cross-sectional view in a direction perpendicular to the substrates 10 and 20, the height t3 of each of the address electrodes 112 is smaller than the height t₄ of each of the sustain electrodes 31, and the height t₃ of each of the address electrodes 112 is smaller than the height t₅ of each of the scan electrodes 32.

For this reason, as compared with the address pulses supplied to the address electrodes 112, relatively high-voltage sustain pulses can be stably supplied to the sustain electrodes 31 and the scan electrodes 32.

Furthermore, the thickness t₃ of each of the protruding portions 112a of the address electrodes 112, the thickness t₄, of each of the floating portions 31a of the sustain electrodes 31, and the thickness t₅₁ of each of the floating portions 32a of the scan electrodes 32 can be equal to one another in a cross-sectional view in a direction perpendicular to the substrates 10 and 20 (t₃=t₄₁=t₅₁).

As such, with the same thickness, the trigger discharge between the protruding portions 112a and the floating portion 31a and between the protruding portions 112a and the floating portion 32a can be formed with the opposed discharge, such that the discharge firing voltage can be further reduced.

Furthermore, the sustain electrodes 31 and the scan electrodes 32 generate a full-scale sustain discharge, and the floating portions 31a and the floating portions 32a generate the trigger discharge at the beginning of the discharge. Therefore, in a cross-sectional view in the direction perpendicular to the substrates 10 and 20, the height t₄ of each of the sustain electrodes 31 is preferably larger than the height t₄₁ of each of the floating portions 31a thereof. Furthermore, the height t₅ of each of the scan electrodes 32 is preferably larger than the height t₅, of each of the floating portions 32a thereof.

The sustain electrodes 31, the scan electrodes 32, and the address electrodes 112 are preferably made of metal having a superior conductivity since they are provided between the rear-substrate-side barrier rib 16 and the front-substrate-side barrier rib 26 as a non-light-emitting region. The floating portions 31 a and 32a of the sustain electrodes 31 and the scan electrodes 32 are preferably made of metal. The protruding portions 112a of the address electrodes 112 can be made of metal. Alternatively, the protruding portions 112a of the address electrodes can be made of a transparent material to transmit visible light.

The sustain electrodes 31, the scan electrodes 32, and the address electrodes 112 are provided with dielectric layers 34 and 35 formed on outer surfaces thereof. The dielectric layers 34 and 35 accumulate wall charges and also form an insulated structure of the respective electrodes.

The dielectric layer 34 formed on the outer surfaces of the sustain electrodes 31 and the scan electrodes 32 and the dielectric layer 35 formed on the outer surfaces of the address electrodes 112 have matrix structures corresponding to the structures of the rear-substrate-side barrier rib 16 and the front-substrate-side barrier rib 26 so as to have the same structure as those of the discharge cells 17.

The sustain electrodes 31, the scan electrodes 32, and the address electrodes 112 covered with the dielectric layers 34 and 35 can be formed by a Thick Film Ceramic Sheet (TFCS) method. That is, these electrodes can be manufactured by separately forming an electrode section including the sustain electrodes 31, the scan electrodes 32, and the address electrodes 112, and then by attaching the electrode section to the rear substrate 10.

Furthermore, the electrode section can be formed by forming the address electrodes 112 having the protruding portions 112a, the floating portions 31 a of the sustain electrodes 31, and the floating portions 32a of the scan electrodes 32 together by a printing method, by coating a dielectric thereon to form the dielectric layers 34 and 35, and then forming the sustain electrodes 31 and the scan electrodes 32 by a printing method.

Furthermore, the dielectric layers 34 and 35 covering the address electrodes 112, the sustain electrodes 31, and the scan electrodes 32 can be formed by dipping the electrodes into a liquid dielectric, drying the dielectric, and then etching the dielectric by various methods, such as a sand blasting method, a photosensitive dielectric method, or a laser patterning method.

The dielectric layers 34 and 35 covering the sustain electrodes 31, the scan electrodes 32, and the address electrodes 112 can be provided with a protective film 36 formed on the surfaces thereof. In particular, the protective film 36 can be formed on the portions exposed to the plasma discharge generated in the discharge spaces 18 and 28 in the discharge cells 17. The protective film 36 is required to protect the dielectric layers 34 and 35 and to have a high secondary electron emission coefficient, but does not need to have a transmissive property for visible light.

That is, the sustain electrodes 31, the scan electrodes 32, and the address electrodes 112 are provided between both substrates 10 and 20, and not on the front substrate 20 and the rear substrate 10. Therefore, the protective film 36, which is coated on the dielectric layers 34 and 35 covering the sustain electrodes 31, the scan electrodes 32, and the address electrodes 112, can be made of a material having a non-transmissive property for visible light.

As an example of the protective film 36, an MgO film having a non-transmissive property for visible light has a much higher secondary electron emission coefficient than that of an MgO film having a transmissive property for visible light, such that the discharge firing voltage can be further reduced.

The address electrodes 112 are surrounded by the dielectric layer 35 having a constant dielectric constant, and thus the phosphor layers 19 and 29 of the red (R), green (G), and blue (B) colors have the same discharge firing voltage, thereby forming a high voltage margin.

On the other hand, as described above, the sustain electrodes 31 and the floating portions 31 a thereof are provided between the second barrier rib members 16b and the fourth barrier rib members 26b, which form one side of the discharge cells 17 (one side in the y-axis direction), so as to be shared by the discharge cells 17 corresponding to the second and fourth barrier rib members 16b and 26b.

The scan electrodes 32 and the floating portions 32a thereof are provided between the second barrier rib members 16b and the fourth barrier rib members 26b, which form the other side of the discharge cells 17, so as to be shared by the discharge cells 17 corresponding to the 18 second and fourth barrier rib members 16b and 26b.

Therefore, the sustain electrodes 31 and the floating portions 31a thereof and the scan electrodes 32 and the floating portions 32a thereof are disposed according to the electrode arrangement in an order of the sustain electrode 31, the floating portion 31a thereof, the scan electrode 32, the floating portion 32a thereof, the sustain electrode 31, and the floating portion 31a, with respect to the discharge cells 17 continuously disposed in the y-axis direction.

Furthermore, the address electrodes 112 are provided between the first barrier rib members 16a and the third barrier ribs 26a, which form one side of the discharge cells 17 in the x-axis direction, corresponding to the first and third barrier rib members 16a and 26a. The protruding portions 112a of the address electrodes 112 are correspondingly disposed at the centers of the discharge cells 17.

Therefore, the electrode arrangement of the sustain electrode 31, the scan electrode 32, and the sustain electrode 31 is in an order of the sustain electrode 31, the floating portion 31 a thereof, the protruding portion 112a of the address electrode 112, the scan electrode 32, the floating portion 32a thereof, the protruding portion 112a of the address electrode 112, the sustain electrode 31, and the floating portion 31 a thereof along the y-axis direction.

Various embodiment of the present invention are described below. The second to fourth embodiments described below have configurations equal or similar to the configuration of the first embodiment. Accordingly, detailed descriptions of the same parts have been omitted, and only different parts are described below.

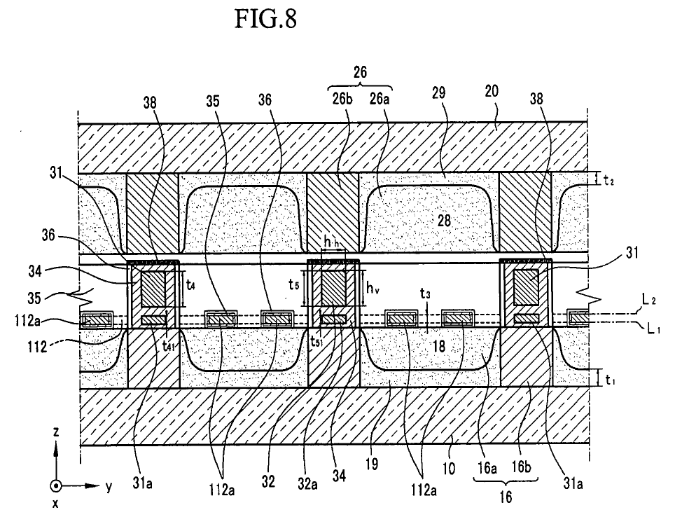

FIGS. 8 to 10 are cross-sectional views of PDPs according to the second to fourth embodiments of the present invention.

FIG. 8 relates to the second embodiment of the present invention. In the first embodiment, the dielectric layer 34 simply covers the sustain electrodes 31 and the scan electrodes 32. On the other hand, in the second embodiment, the dielectric layer 34 further has a black layer 38 on the front substrate 20.

In the second embodiment, the dielectric layer 34 is preferably made of a black dielectric in order to enhance contrast.

If the dielectric layer 34 is made of dielectric materials other than a black dielectric material, in order to enhance contrast, the dielectric layer 34 further has a black layer 38 on the front substrate 20.

In FIG. 8, the black layer 38 is formed on the dielectric layer 34 covering only the sustain electrodes 31 and the scan electrodes 32. However, the black layer can be formed on the dielectric layer 35 covering the address electrodes 112 (not shown).

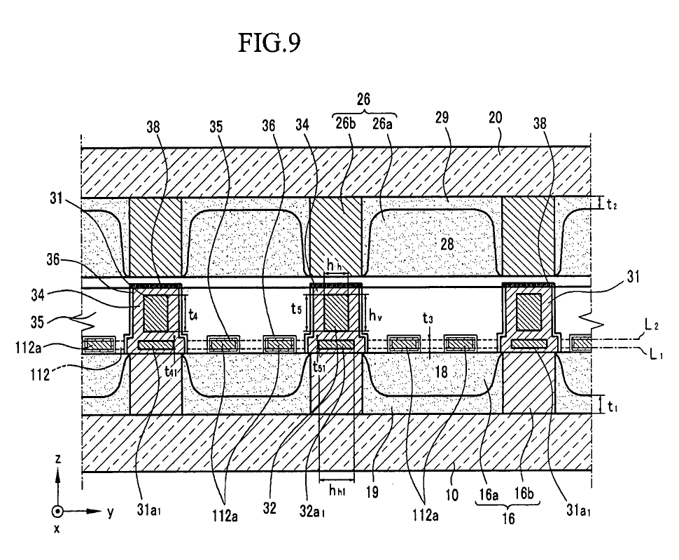

FIG. 9 relates to the third embodiment of the present invention. In the second embodiment, the horizontal length hₕ of each of the floating portions 31 a of the sustain electrodes 31 and the floating portions 32a of the scan electrodes 32 is to be equal to the horizontal length hₕ of each of the sustain electrodes 31 and the scan electrodes 32 in cross-sectional view in a direction perpendicular to the planes of the substrates 10 and 20.

On the other hand, in the third embodiment, the horizontal length hₕ₁ of each of floating portions 31a, of the sustain electrodes 31 and floating portions 32a₁ of the scan electrodes 32 is larger than the horizontal length hₕ of each of the sustain electrodes 31 and the scan electrodes 32 in cross-sectional view in the direction perpendicular to the planes of the substrates 10 and 20.

For this reason, the discharge gaps between the floating portions 31a₁ and 32a₁ and the protruding portion 112a are shorter than the discharge gap of the second embodiment. Therefore, a discharge firing voltage and a voltage for the trigger discharge can be further reduced.

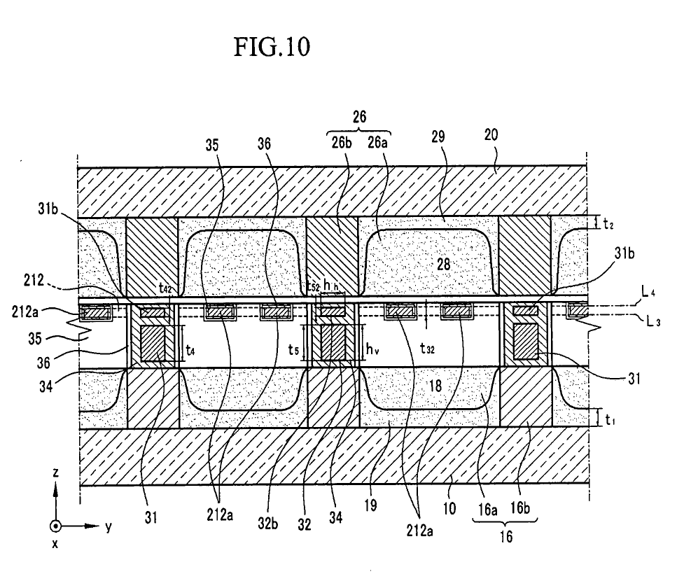

FIG. 10 relates to the fourth embodiment. In the first embodiment, the address electrodes 112, the protruding portions 112a thereof, the floating portions 31 a of the sustain electrodes 31, and the floating portions 32a of the scan electrodes 32 are disposed on the rear substrate 10. On the other hand, in the fourth embodiment, address electrodes 212, protruding portions 212a thereof, floating portions 31b of the sustain electrodes 31, and floating portions 32b of the scan electrodes 32 are disposed on the front substrate 20.

That is, between the rear-substrate-side barrier rib 16 and the front-substrate-side barrier rib 26, the address electrodes 212, the protruding portions 212a thereof, and the floating portions 31b and 32b of the sustain electrodes 31 and the scan electrodes 32 corresponding to the protruding portions 212a are adjacent to the front substrate 20. The sustain electrodes 31 and the scan electrodes 32 are disposed adjacent to the rear substrate 10, and the protruding portions 212a of the address electrodes 212 and the floating portions 31b and 32b of the sustain electrodes 31 and the scan electrodes 32 are arranged on the same line (L3 to L4) in a direction parallel to the planes of the substrates 10 and 20.

For this reason, while the address discharge and the trigger discharge are generated in the discharge spaces 18 adjacent to the rear substrate 10, that is, the discharge cells 17 in the first embodiment, the address discharge and the trigger discharge are generated in the discharge spaces 28 adjacent to the front substrate 20, that is, the discharge cells 17.

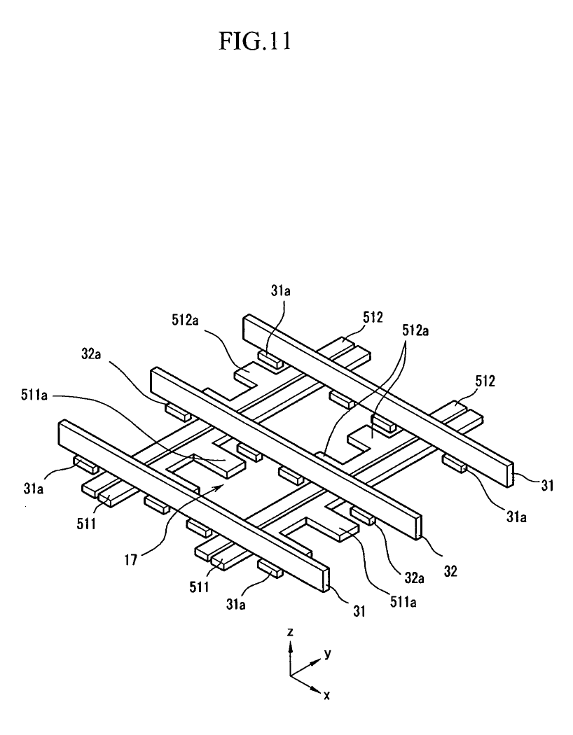

FIG. 11 is a perspective view of the structures of electrodes in a PDP according to a fifth embodiment of the present invention.

Referring to FIG. 11, unlike in the first to fourth embodiments, in the fifth embodiment two address electrodes, that is, first and second address electrodes 511 and 512 are provided in one discharge cell 17.

The first and second address electrodes 511 and 512 are respectively arranged on either side of one discharge cell 17, but, in the discharge cells 17 continuously disposed in the y-axis direction, protruding portions 511a of the first address electrodes 511 are arranged to correspond to an even-numbered group and protruding portions 512a of the second address electrodes 512 are arranged to correspond to an odd-numbered group. Furthermore, the protruding portions 511a and 512a can be respectively disposed in the discharge cells 17 of the odd-numbered group and the even-numbered group.

The floating portions 3 la and 32a of the sustain electrode 31 and the scan electrode 32 are provided on both sides of each of the protruding portions 511a and 512a.

The first address electrodes 511 and the second address electrodes 512 intersect the sustain electrodes 31 and the scan electrodes 32 and are disposed in parallel to correspond to the respective discharge cells 17 in pairs. The first address electrodes 511 and the second address electrodes 512 are involved in the address discharge of adjacent discharge cells 17.

With reference to one discharge cell 17, the first and second address electrodes 511 and 512 are disposed in a pair. The first address electrode 511 is involved in the address discharge of one discharge cell 17. The second address electrode 512 is involved in the address discharge of another discharge cell 17 adjacent to the discharge cell 17, which is addressed by the first address electrode 511.

Therefore, the first address electrodes 511 and the second address electrodes 512 are alternately involved in the address discharge with respect to the discharge cells 17 continuously disposed along the y-axis direction. This PDP is suitable for realizing high definition.

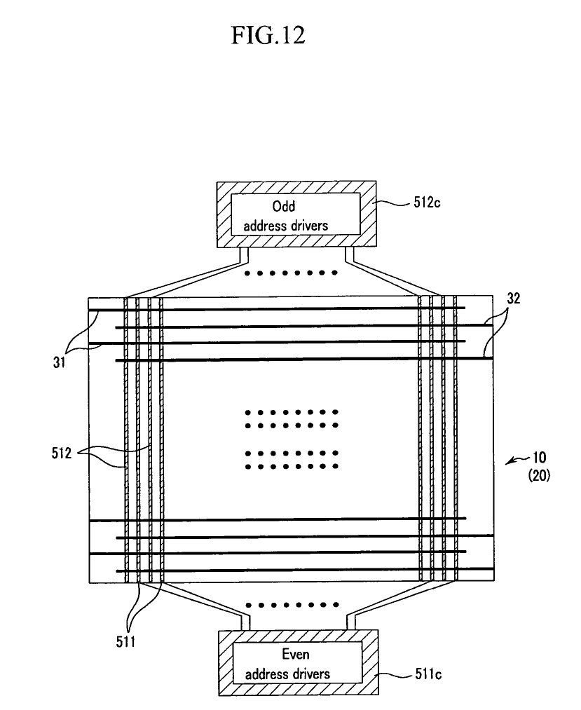

FIG. 12 is a schematic view showing the connection relationship of the first address electrodes and the second address electrode and respective drivers in the PDP according to the fifth embodiment of the present invention.

Referring to FIG. 12, the first address electrodes 511 extend to one side of the substrates 10 and 20 and connect to a first address electrode driver 511 c, and the second address electrodes 512 extend to the other side of the substrates 10 and 20 and connect to a second address electrode driver 512c. This enables adjacent discharge cells 17 sharing the scan electrode 32 to be simultaneously addressed by one scan operation.

As such, the first and second address electrodes 511 and 512 extend to both sides of the substrates 10 and 20 and are supplied with the address pulses, and thus, electromagnetic noise can be reduced.

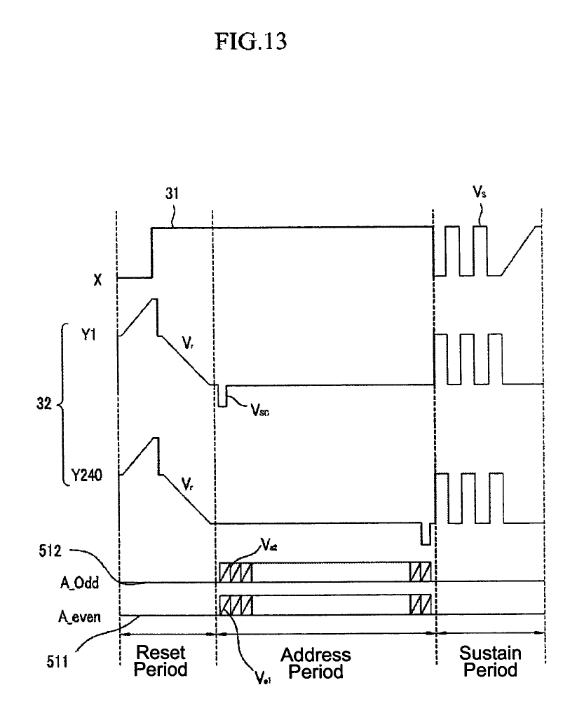

FIG. 13 is a waveform diagram of a method of driving a PDP according to the fifth embodiment of the present invention.

Referring to FIG. 13, the method of driving a PDP includes, in the address period, supplying a scan pulse Vsc to a scan electrode 32, which is shared by adjacent discharge cells 17, and addressing the discharge cells 17, to which the scan pulse Vsc has been supplied.

In addressing the discharge cells 17, one of two adjacent discharge cells 17 is addressed by the first address electrode 511 with an address pulse Vₐ₁, and the other discharge cell 17 is addressed by the second address electrode 512 with an address pulse Vₐ₂.

In a resetting before addressing, a reset pulse Vr is supplied to one scan electrode 32, such that two adjacent discharge cells 17 are simultaneously reset through the interaction of the scan electrode 32 and the sustain electrodes 31 provided on both sides of the scan electrode 32.

Since the reset pulse Vr is supplied during a reset period, a pulse having a known waveform can be used. Furthermore, since the sustain pulse Vs is supplied during a sustain period, a pulse having a known waveform can be used.

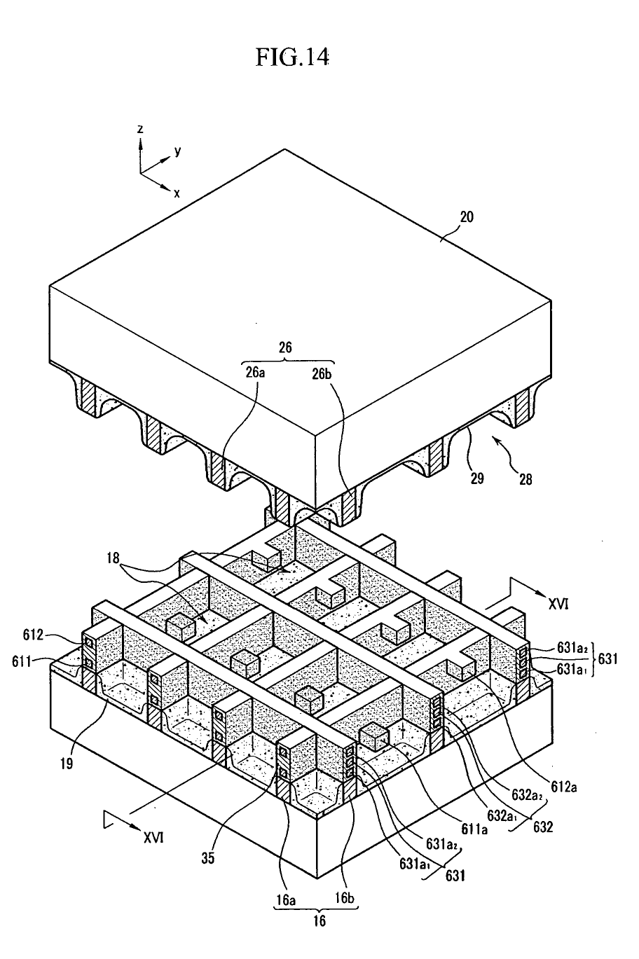

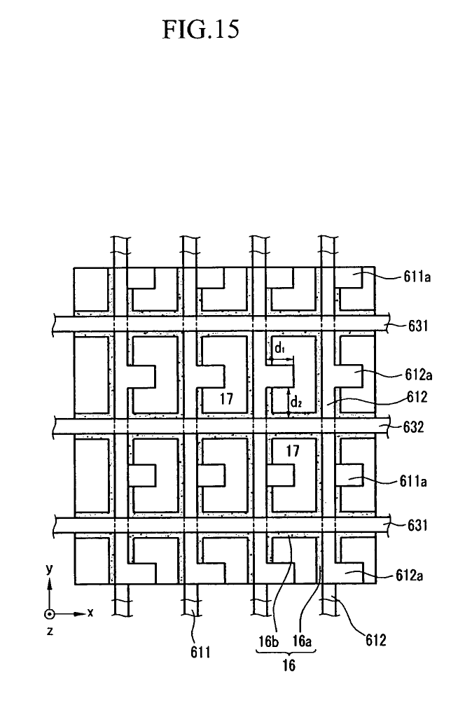

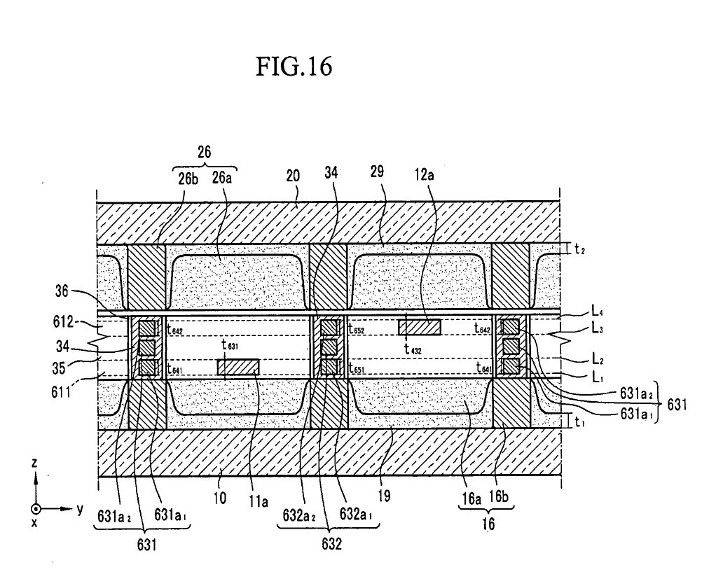

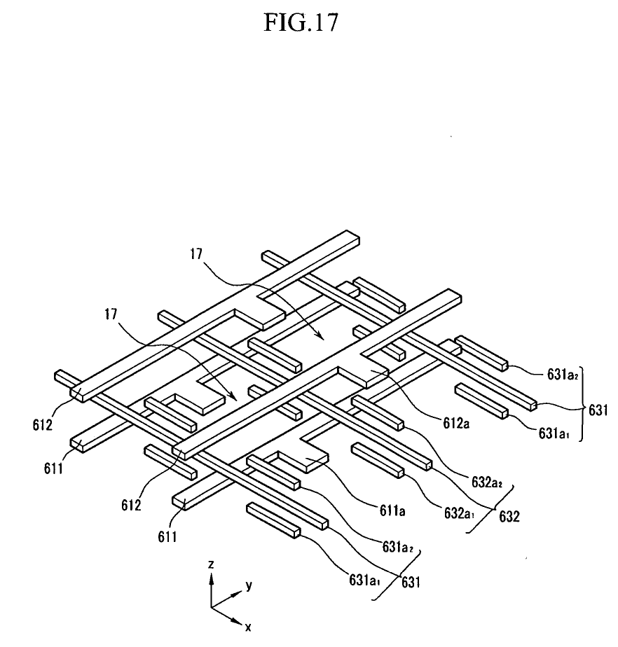

FIG. 14 is a partially exploded perspective view of a PDP according to a sixth embodiment of the present invention. FIG. 15 is a plan view of the structures of electrodes and discharge cells in the PDP according to the sixth embodiment of the present invention. FIG. 16 is a cross-sectional view taken along the line XVI-XVI of FIG. 14 when the PDP is assembled. FIG. 17 is a perspective view of the structures of the electrodes in the PDP according to the sixth embodiment of the present invention.

Referring to FIGS. 14 to 17, the sixth embodiment is partially similar to the fifth embodiment in that two address electrodes, that is, first address electrodes 611 and second address electrodes 612 are provided. The sixth embodiment is different from the first to fifth embodiment in that each of sustain electrodes 631 and scan electrodes 632 is divided into at least two portions.

As shown in FIG. 15, the sustain electrodes 631 and the scan electrodes 632 are alternately disposed on both sides of the respective discharge cells 17 in the y-axis direction between the rear-substrate-side barrier rib 16 and the front-substrate-side barrier rib 26 and extend in parallel. Each of the sustain electrodes 631 and the scan electrodes 632 is shared by adjacent discharge cells 17 on each side and is divided into two portions so as to form an opposed discharge structure.

Each of the sustain electrodes 631 is shared on one side of adjacent discharge cells 17 in the y-axis direction on the basis of one discharge cell 17. Each of the scan electrodes 632 is shared at the other side of adjacent discharge cells 17 in the y-axis direction. For this reason, the sustain electrode 631 and the scan electrode 632 are involved in the sustain discharge of two adjacent discharge cells 17 at each side.

The first address electrodes 611 and the second address electrodes 612 can be disposed to overlap each other on one of the rear-substrate-side barrier rib 16 and the front-substrate-side barrier rib 26 between the rear-substrate-side barrier rib 16 and the front-substrate-side barrier rib 26 on the basis of an electrode layer (not shown) or can be disposed on both sides, correspondingly.

In the sixth embodiment, the first address electrodes 611 are provided on the rear-substrate-side barrier rib 16, and the second address electrodes 612 are provided on the front-substrate-side barrier rib 26. The first address electrodes 611 and the second address electrodes 612 are provided on the same side of the respective discharge cells 17 in the x-axis direction.

Therefore, the first address electrodes 611 and the second address electrodes 612 are provided on the same side of the respective discharge cells 17 along the x-axis direction. The first address electrodes 611 and the second address electrodes 612 are respectively provided on the rear substrate 10 and the front substrate 20.

The first and second address electrodes 611 and 612 have protruding portions 611a and 612a that respectively protrude toward the centers of the respective discharge cells 17 disposed in the extension direction (y-axis direction).

Even when the first address electrodes 611 and the second address electrodes 612 are disposed on the same side of the respective discharge cells 17, the protruding portions 611 a and 612a can alternately address adjacent discharge cells 17 in the y-axis direction.

FIG. 16 exemplifies the configuration in which the first address electrodes 611 are provided on the rear-substrate-side barrier rib 16 and the second address electrodes 612 are provided on the front-substrate-side barrier rib 26.

The first address electrodes 611 and the second address electrodes 612 intersect the sustain electrodes 631 and the scan electrodes 632 and have the protruding portions 61 la and 612a that alternately correspond to the discharge cells 17 disposed in the y-axis direction.

Regarding one discharge cell 17, the first address electrode 611 and the second discharge cell 612 are disposed on the same side in a pair. The first address electrode 611 and the protruding portion 611 a thereof are involved in addressing of one of adjacent discharge cells 17. Furthermore, the second address electrode 612 and the protruding portion 612a are involved in addressing of the other discharge cell 17 adjacent to the discharge cell 17 which is addressed by the first address electrode 611.

In such a manner, the first address electrodes 611 and the second address electrodes 612 alternately address the discharge cells 17 continuously disposed in the y-axis direction.

The first and second address electrodes 611 and 612 are disposed between the rear-substrate-side barrier rib 16 and the front-substrate-side barrier rib 26 in the z-axis direction of the rear substrate 10 and the front substrate 20 with the sustain electrode 631 and the scan electrode 632 interposed therebetween. The first address electrodes 611 are disposed to correspond to the first barrier rib members 16a and the second address electrodes 612 are disposed to correspond to the third barrier rib members 26a.

A plurality of first address electrodes 611 are disposed in parallel at gaps corresponding to the discharge cells 17 in the x-axis direction. Furthermore, a plurality of second address electrodes 612 are disposed in parallel at gaps corresponding to the discharge cells 17 in the x-axis direction.

As such, the first address electrodes 611 and the second address electrodes 612 are provided on the rear-substrate-side barrier rib 16 and the front-substrate-side barrier rib 26 when the scan electrodes 631 and the scan electrodes 632 are disposed at the centers of the respective discharge cells 17. Accordingly, the first and second address electrodes 611 and 612 do not interfere with the sustain electrodes 631 and the scan electrodes 632.

The first address electrode 611 and the second address electrode 612 are disposed on the same side of one discharge cell 17, but the protruding portions 611a of the first address electrodes 611 are formed to correspond to an even-numbered group of the discharge cells 17 continuously disposed and the protruding portions 612a of the second address electrodes 612 are formed to correspond to an odd-numbered group of the discharge cells 17 continuously disposed. Furthermore, the protruding portions 611a and 612a can be respectively disposed in the discharge cells 17 of the odd-numbered group and the discharge cells 17 of the even-numbered group.

The first address electrode 611 and the second address electrode 612 perform addressing through the interaction with the scan electrode 632. The protruding portion 611 a of the first address electrode 611 protrudes toward the center of one discharge cell 17 sharing the scan electrode 632 and the protruding portion 612a of the second address electrode 612 protrudes toward the center of the other discharge cell 17 sharing the same scan electrode 632. The protruding portion 611 a and the protruding portion 612a are alternately disposed with respect to the discharge cells 17 arranged along the y-axis direction.

The first address electrodes 611 and the second address electrodes 612 are provided in a non-light-emitting region between the first barrier rib members 16a and the third barrier rib members 26a. The first address electrodes 611 and the second address electrodes 612 do not shield visible light generated by the discharge cells 17. Therefore, the first address electrodes 611 and the second address electrodes 612 can be made of non-transparent materials or a metal having superior conductivity.

Each of the protruding portions 61 la and 612a protrudes toward the center of the discharge cell 17, and thus the protruding portions 611 a and 612a should be transparent electrodes. The protruding portions 611 a and 612a can be made of the same material as that of the first address electrodes 611 and the second address electrodes 612.

Each of the protruding portions 61 la and 612a of the first address electrodes 611 and the second address electrodes 612 supplies the address pulse to the discharge cell 17. If the scan pulse is supplied to the scan electrode 632 and the address pulses are supplied to the first address electrode 611 and the second address electrode 612, double addressing can be realized by one scan operation.

Furthermore, the discharge gaps between the protruding portions 611a and 612a and the scan electrode 632 are short gaps, thereby enabling an address discharge with a low voltage.

On the other hand, the sustain electrode 631 and the scan electrode 632 are disposed between the rear-substrate-side barrier rib 16 and the front-substrate-side barrier rib 26, which constitute the discharge cell 17, with respect to the z-axis direction of the rear substrate 10 and the front substrate 20. The sustain electrode 631 and the scan electrode 632 are electrically insulated from the first address electrode 611 and the second address electrode 612 to extend along the x-axis direction intersecting the first and second address electrodes 611 and 612. Each of the sustain electrode 631 and the scan electrode 632 is divided into two or more portions.

The two portions in each of the sustain electrode 631 and the scan electrode 632 are a portion that extends along the x-axis direction and a portion that is separated from that portion in the z-axis direction, or two portions that extend in the x-axis direction.

First, it is assumed that the two portions are the extending portion and the portion separated from the extending portion. When each of the sustain electrode 631 and the scan electrode 632 is formed with two portions, a pulse may be supplied to one portion or pulses can be supplied to the two portions.

Furthermore, when the extending portions from the sustain electrode 631 and the sustain electrode 632 are a plurality of pieces, pulses can be supplied to one piece of the sustain electrode 631 and one piece of the scan electrode 632. Alternatively, the pulses can be supplied to all of the pieces of the sustain electrode 631 and all of the pieces of the scan electrode 632.

The sustain electrode 631 and the scan electrode 632 then have respective portions separated from in the z-axis direction, that is, floating portions 31a and 32a.

The sustain electrode 631 and the scan electrode 632 include first floating portions 631 a₁ and 632a₁ that are provided on the rear substrate 10 corresponding to the discharge cell 17 and second floating portions 631a₂ and 632a₂ that are provided on the front substrate 20 corresponding to the first floating portions 631a₁ and 632a₁.

If a pulse is supplied to the sustain electrode 631 and the scan electrode 632, a pulse having a voltage lower than the voltage of the supplied pulse is supplied to the first floating portions 631a₁ and 632a₁ and the second floating portions 631 a₂ and 632a₂.

The protruding portion 611a of the first address electrode 611 is provided between the first floating portion 631a₁ of the sustain electrode 631 and the first floating portions 632a₁ of the scan electrode 632, and the protruding portion 612a of the second address electrode 612 is provided between the second floating portion 631a₂ of the sustain electrode 631 and the second 18 floating portion 632a₂ of the scan electrode 632.

Between the rear-substrate-side barrier rib 16 and the front-substrate-side barrier rib 26, the first address electrode 611 and the protruding portion 611a thereof, and the first floating portions 631a₁ and 632a₁ of the sustain electrode 631 and the scan electrode 632 corresponding to the protruding portion 611a are provided adjacent to the rear substrate 10, and the second address electrode 612 and the protruding portion 612a thereof, and the second floating portions 631 a₂ and 632a₂ of the sustain electrode 631 and the scan electrode 632 corresponding to the protruding portion 612a are provided adjacent to the front substrate 20, with the sustain electrode 631 and the scan electrode 632 interposed therebetween.

The protruding portion 61 la of the first address electrode 611 and the first floating portions 631a₁ and 632a₁ of the sustain electrode 631 and the scan electrode 632 corresponding to the protruding portion 611a are on the same line (L1 to L2) in a direction parallel to the planes of the substrates 10 and 20.

The protruding portion 612a of the second address electrode 612 and the second floating portions 631a₂ and 632a₂ of the sustain electrode 631 and the scan electrode 632 corresponding to the protruding portion 612a are on the same line (L3 to L4) in a direction parallel to the planes of the substrates 10 and 20.

The protruding portion 611 a of the first address electrode 611 and the first floating portions 631a₁ and 632a₁ of the sustain electrode 631 and the scan electrode 632 corresponding to the protruding portion 611a have the same cross-sectional thickness in a direction perpendicular to the planes of the substrates 10 and 20 (t₆₃₁=t₆₄₁=t₆₅₁).

The protruding portion 612a of the second address electrode 612 and the second floating portions 631a₂ and 632a₂ of the sustain electrode 631 and the scan electrode 632 corresponding to the protruding portion 612a have the same thickness in cross-sectional view in a direction perpendicular to the planes of the substrates 10 and 20 (t₆₃₂=t₆₄₂=t₆₅₂).

For this reason, the protruding portion 61 la of the first address electrode 611 and the first floating portion 632a₁ of the scan electrode 632 form an opposed discharge structure, and the protruding portion 612a of the second address electrode 612 and the second floating portion 632a₂ of the scan electrode 632 form an opposed discharge structure. Therefore, an address discharge with a low voltage can be realized.

The sustain electrode 631 and the first and second floating portions 631a₁ and 631a₂ thereof are disposed at one side of the discharge cell 17, and the scan electrode 632 and the first 8 and second floating portions 632a₁ and 632a₂ thereof are disposed at the other side of the discharge cell 17 parallel to the sustain electrode 631 and the first and second floating portions 631a₁ and 631a₂ thereof.

The sustain electrode 631 and the first and second floating portions 631a₁ and 631a₂ thereof and the scan electrode 632 and the first and second floating portions 632a, and 632a ₂ thereof are alternately disposed so as to be shared by adjacent discharge cells 17 of the continuously disposed discharge cells 17.

That is, with reference to two continuously disposed discharge cells 17, the scan electrode 632 and the first and second floating portions 632a₁ and 632a₂ thereof are provided between the second barrier rib member 16b and the fourth barrier rib member 26b, which divide the two discharge cells 17.

Of course, the sustain electrode 631 and the first and second floating portions 631a₁ and 631a₂ thereof are also provided between the second barrier rib member 16b and the fourth barrier rib member 26b, which divide two adjacent discharge cells 17.

Therefore, when the address pulse is supplied to the first address electrode 611 and the second address electrode 612 and the scan pulse is supplied to the scan electrode 632, double addressing can be realized in which two adjacent discharge cells 17 are selected by one scan operation, thereby reducing the address period.

Furthermore, if the reset pulse is supplied to the scan electrode 632, two discharge cells 17 which share the scan electrode 632 are reset, thereby reducing the reset period.

As such, since the reset period and the address period are reduced, the sustain period can be increased. With an increase in the sustain period, the number of sustain pulses is increased, thereby enhancing the power of gray-scale representation.

As shown in FIG. 17, the sustain electrode 631 and the first and second floating portions 631a₁ and 631a₂ thereof and the scan electrode 632 and the first and second floating portions 632a₁ and 632a₂ thereof are arranged such that, for adjacent discharge cells 17 in the y-axis direction, double addressing can be realized by one scan operation.

In one discharge cell 17 which shares the scan electrode 632 and the first and second floating portions 632a₁ and 632a₂ thereof, the protruding portion 611a of the first address electrode 611 is provided. In the other discharge cell 17 which shares the scan electrode 632f and the first and second floating portions 632a₁ and 632a₂ thereof, the protruding portion 612a of the second address electrode 612 is provided.

The protruding portion 611a triggers the discharge between the first floating portion 631a₁ of the sustain electrode 631 and the first floating portion 632a₁ of the scan electrode 632 and enables a sustain discharge with a low voltage. Furthermore, the protruding portion 612a. triggers the discharge between the second floating portion 631a₂ of the sustain electrode 631 and the second floating portion 632a₂ of the scan electrode 632 and enables a sustain discharge with low voltage.

The sustain electrode 631 and the first and second floating portions 631a₁ and 631a₂ thereof and the scan electrode 632 and the first and second floating portions 632a₁ and 632a₂ thereof are disposed between the second barrier rib member 16b and the fourth barrier rib member 26b, thereby serving as the reference to divide adjacent discharge cells 17 in the y-axis direction.

The scan electrode 632 and the first and second floating portions 632a₁ and 632a₂ thereof are involved in addressing in the address period, together with the first address electrode 611 and the protruding portion 611a thereof and the second address electrode 612 and the protruding portion 612a thereof, and serve to select the discharge cell 17 to be turned on.

The sustain electrode 631 and the first and second floating portions 631a₁ and 631a₂ thereof and the scan electrode 632 and the first and second floating portions 632a₁ and 632a₂ thereof are involved in the sustain discharge in the sustain period, and serve to display an image on the screen.

That is, the sustain electrode 631 is supplied with the sustain pulse in the sustain period, and the scan electrode 632 is supplied with the sustain pulse in the sustain period and with the scan pulse in the address period. However, the respective electrodes can perform different functions in accordance with the signal voltages supplied thereto, and thus, the sixth embodiment does not need to be limited to the above-described configuration.

The sustain electrode 631 and the scan electrode 632 are provided between both substrates 10 and 20 to divide one discharge cell 17 in the z-axis direction together with the first address electrode 611 and the second address electrode 612, such that the opposed discharge structure is formed. Therefore, the discharge firing voltage for the sustain discharge can be reduced.

The sustain electrode 631 and the first and second floating portions 631a₁ and 631a₂ thereof and the scan electrode 632 and the first and second floating portions 632a₁ and 632a₂ thereof induce the opposite surface discharge over a wider area. The opposed discharge over the wide area in such a manner generates strong vacuum ultraviolet rays. The strong vacuum ultraviolet rays collide against the first and second phosphor layers 19 and 29 over the wide area inside the discharge cells 17, such that the resultant amount of visible light is increased.

Furthermore, the sustain electrode 631 and the first and second floating portions 631a₁ and 631a₂ thereof and the scan electrode 632 and the first and second floating portions 632a₁ and 632a₂ thereof are provided between the second barrier rib member 16b and the fourth barrier rib member 26b as the non-light-emitting region so as not to shield visible light generated by the discharge cell 17. Therefore, they can be made of non-transparent materials or can be made of a metal having superior conductivity.

The sustain electrode 631 and the first and second floating portions 631a₁ and 631a₂ thereof and the scan electrode 632 and the first and second floating portions 632a₁ and 632a₂ thereof form symmetric structures in the x-axis direction in cross-sectional view (y-z plane) in a direction perpendicular to the planes of the front substrate 10 and the rear substrate 20. For this reason, the sustain electrode 631 and the scan electrode 632 form an opposed discharge structure with the discharge cell 17 interposed therebetween.

The sustain electrode 631 and the scan electrode 632 form an opposed discharge structures together with the first floating portions 631a₁ and 632a, and the second floating portions 631a₂ and 632a₂ in the discharge cell 17, thereby reducing the discharge firing voltage. Furthermore, since two discharge cells 17 share the scan electrode 632, double resetting can be realized by one reset operation, and double addressing can be realized by one scan operation. Therefore, the reset period and the address period can be reduced.

The sustain electrode 631, the scan electrode 632, the first address electrode 611, and the second address electrode 612 can be provided with the dielectric layers 34 and 35 on the outer surfaces thereof so as to form an electrode layer. A protective film 36 can be provided on the outer surfaces of the dielectric layers 34 and 35.

On the other hand, each of the protruding portions 611a and 61 2a of the first and second address electrodes 611 and 612 is preferably formed to have a distance d1 protruding inside the discharge cell 17 greater than zero (0) (d₁>0), such that one of adjacent discharge cells 17 is selected by the address pulse supplied to the first and second address electrodes 611 and 612 and the scan pulse supplied to the scan electrode 632 (see FIG. 15).

Furthermore, for the opposed discharge between the first and second address electrodes 611 and 612 and the first and second floating portions 632a₁ and 632a₂ of the scan electrode 632, the distance d2 between each of the protruding portions 611a and 612a of the first and second address electrodes 611 and 612 and each of the first and second floating portions 632a₁ and 632a₂ is preferably greater than zero (d₂>0) (see FIG. 15).

In the sixth embodiment, the arrangement of the sustain electrode 631, the scan electrode 632, and the sustain electrode 631 is in an order of the sustain electrode 631 and the first and second floating portions 631a₁ and 631a₂ thereof, the protruding portion 611a of the first address electrode 611, the scan electrode 632 and the first and second floating portions 632a₁ and 632a₂ thereof, the protruding portion 612a of the second address electrode 612, and the sustain electrode 631 and the first and second floating portions 631a₁ and 631a₂ thereof along the y-axis direction, like in the first embodiment.

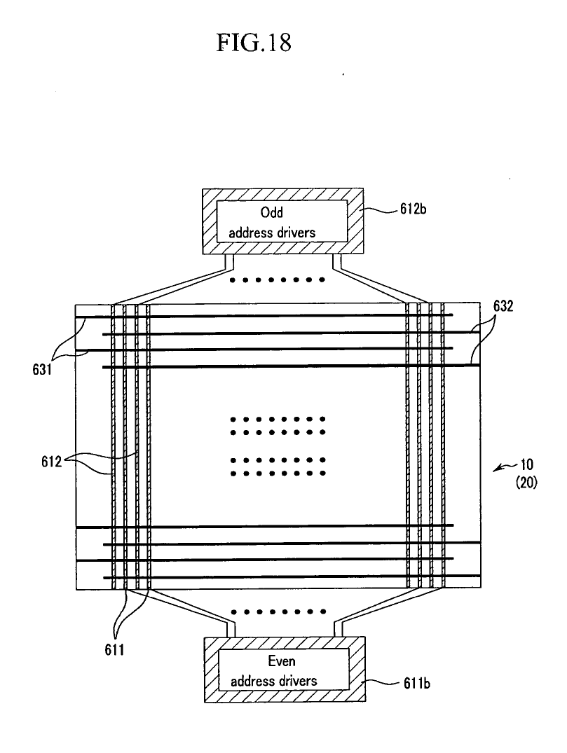

As shown in FIG. 18, the first address electrodes 611 extend to one side of the front substrate 20 and the rear substrate 10 and are connected to a first address electrode driver 611 b, and the second address electrodes 612 extend to the other side of the front substrate 20 and the rear substrate 10 and are connected to a second address electrode driver 612b. This enables adjacent discharge cells 17 sharing the scan electrode 632 to be simultaneously addressed by one scan operation.

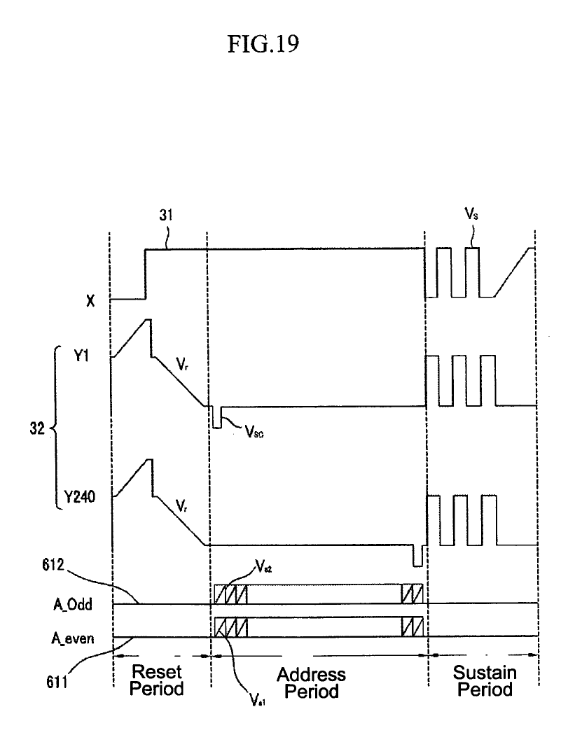

As shown in FIG. 19, the method of driving a PDP includes, in the address period, supplying a scan pulse Vsc to a scan electrode 632, which is shared by adjacent discharge cells 17, and addressing the discharge cells 17, to which the scan pulse is supplied.

In addressing the discharge cells 17, one of two adjacent discharge cells 17 is addressed by the first address electrode 611 with an address pulse Va₁, and the other discharge cell 17 is addressed by the second address electrode 612 with an address pulse Va₂.

The address pulse Va₁ is supplied to the first address period 611 from the first address electrode driver 611b, and the address pulse Va₂ is supplied to the second address period 612 from the second address electrode driver 612b. Addressing by the first address electrode 611 and addressing by the second address electrode 612 are simultaneously realized.

In resetting before addressing the discharge cells 17, a reset pulse Vr is supplied to one scan electrode 632, such that two adjacent discharge cells 17 are simultaneously reset through the interaction of the scan electrode 632 and the sustain electrodes 631 provided on both sides of the scan electrode 632.

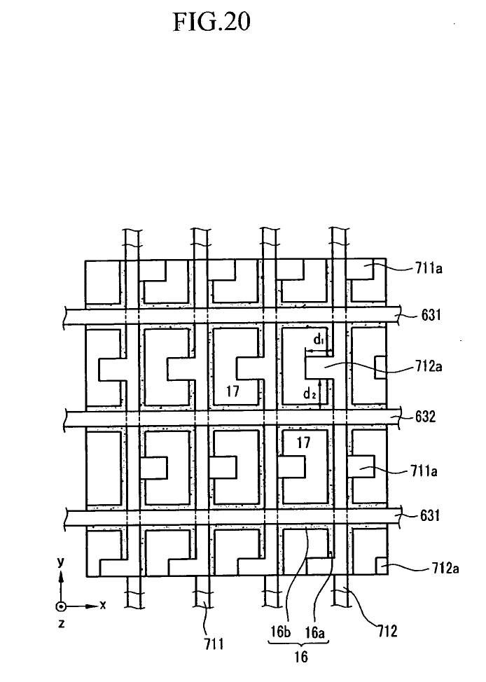

FIG. 20 relates to a seventh embodiment of the present invention. As compared with the sixth embodiment, the seventh embodiment has the configuration in which a first address electrode 711 and a second address electrode 712 are arranged in parallel on both sides in the x-axis direction of each of the discharge cells 17 continuously disposed along the y-axis direction.

A protruding portion 711a of the first address electrode 711 and a protruding portion 712a of the second address electrode 712 alternately protrude toward the centers of the respective discharge cells 17 from both sides of each discharge cell 17.

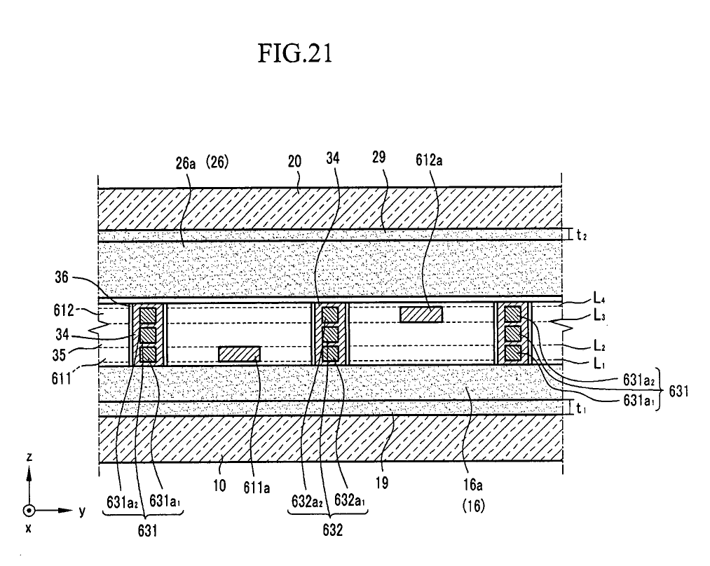

FIG. 21 relates to an eighth embodiment of the present invention. As compared with the sixth and seventh embodiments, the eighth embodiment has a configuration in which the rear-substrate-side barrier rib 16 has first barrier rib members 16a formed in the y-axis direction and the front-substrate-side barrier rib 26 has third barrier rib members 26a formed in the y-axis direction corresponding to the first barrier rib members 16a.

In the sixth and seventh embodiments, the rear-substrate-side barrier rib 16 and the front-substrate-side barrier rib 26 are formed to have matrix barrier rib structures. On the other hand, in the eighth embodiment, the rear-substrate-side barrier rib 16 and the front-substrate-side barrier rib 26 are formed to have stripe barrier rib structures. That is, various barrier rib structures can be used.

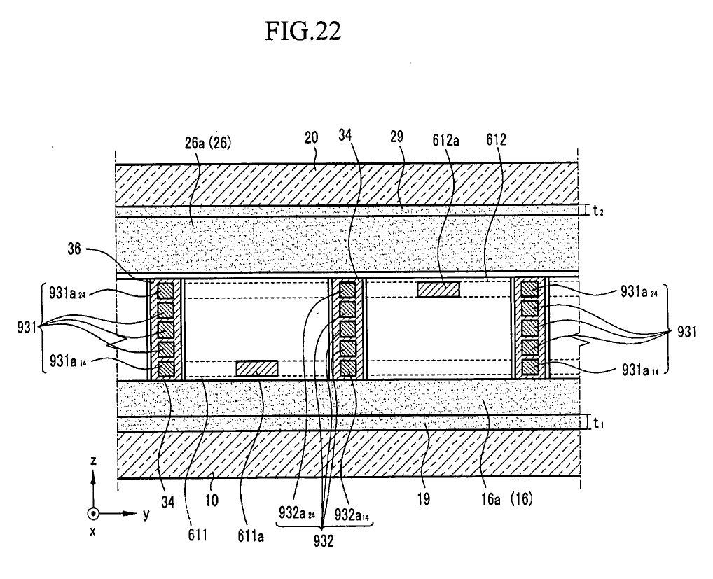

FIGS. 22 to 24 relate to ninth to eleventh embodiments of the present invention.

In the sixth embodiment, each of the portions extending from the sustain electrode 631 and the scan electrode 632 (in the x-axis direction) is formed of one piece. On the contrary, in the ninth to eleventh embodiments, each of the extending portions of a sustain electrode 931, 1031, or 1131 and a scan electrode 932, 1032, or 1132 (in the x-axis direction) are formed of a plurality of pieces.

FIG. 22 relates to the ninth embodiment of the present invention in which each of the extending portions of the sustain electrode 931 and the scan electrode 932 is formed of three pieces. A first floating portion 931a₁₄ or 932a₁₄ and a second floating portion 931a₂₄ or 932a₂₄ are provided on both sides of each of the extending portions. Each of the floating portions is formed of one piece.

Each of the extending portions of the sustain electrode 931 and the scan electrode 932 is formed of one piece, and the first floating portion 931a₁₄ or 932a₁₄ and the second floating portion 931a₂₄ or 932a₂₄ are provided on both sides of each of the extending portions. Each floating portion is formed of two pieces.

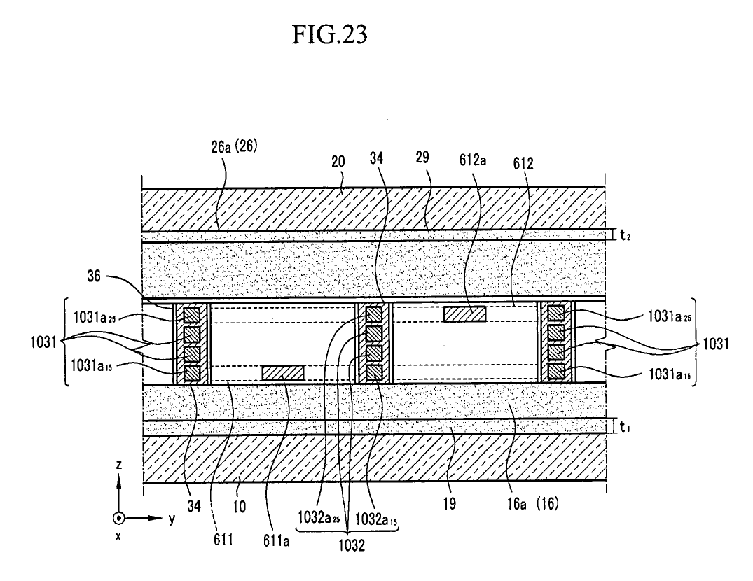

FIG. 23 relates to the tenth embodiment of the present invention in which each of the extending portions of the sustain electrode 1031 and the scan electrode 1032 is formed of two pieces, and a first floating portions 1031a₁₅ or 1032a₁₅ and a second floating portion 1031a₂₅ or 1032a₂₅ are provided on both sides of each of the extending portions. Each floating portion is formed of one piece.

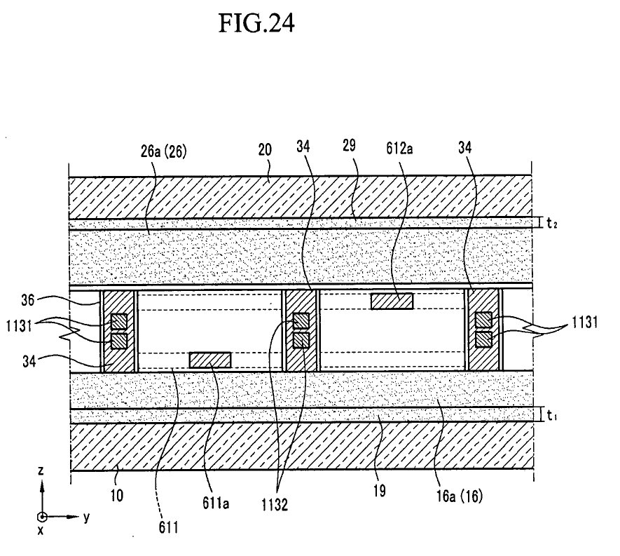

FIG. 24 relates to the eleventh embodiment of the present invention in which each of the extending portions of the sustain electrode 1131 and the scan electrode 1132 is formed of two pieces, and no floating portions are provided on both sides of each of the extending portions. Each of the extending portions of the sustain electrode 1131 and the scan electrode 1132 is formed of one piece, and the floating portions are provided on both sides of each of the extending portions. Each floating portion is formed of one piece.

As described above, according to the present invention, the electrodes are provided between the rear substrate and the front substrate, and, of the electrodes, the sustain electrodes and the scan electrodes are alternately disposed on both sides of the respective discharge cells so as to be shared by adjacent discharge cells. Furthermore, the sustain electrodes and the scan electrodes have the floating portions, and, between the floating portions of the sustain electrode and the scan electrode of each discharge cell, a plurality of protruding portions of the address electrode are provided. Therefore, the protruding portions are used as the trigger electrodes at the time of the address discharge and the sustain discharge, and thus the voltage, which induces the address discharge or the sustain discharge, that is, the discharge firing voltage, can be reduced. Furthermore, with the opposed discharge structure of the sustain electrode and the scan electrode, luminescence efficiency can be enhanced.

As described above, according to the PDP of the present invention, the electrodes are provided between the rear substrate and the front substrate, and, of the electrodes, each of the sustain electrodes and the scan electrodes are divided into two portions. The sustain electrodes and the scan electrodes are alternately disposed on both sides of the respective discharge cells so as to be shared by adjacent discharge cells. The first address electrodes and the second address electrodes are disposed on both substrates, respectively, with the sustain electrodes and the scan electrodes interposed therebetween. The protruding portions of the first and second address electrodes are alternately disposed in the even-numbered discharge cells and the 8 odd-numbered discharge cells. Therefore, with the opposed discharge of the sustain electrodes and the scan electrodes, the discharge firing voltage can be reduced. Furthermore, each scan electrode is shared by adjacent discharge cells, and the even-numbered discharge cell and the odd-numbered discharge cell are simultaneously reset. Therefore, the reset period can be reduced. Furthermore, the first address electrodes and the second address electrodes simultaneously address the even-numbered discharge cells and the odd-numbered discharge cells, and thus the address period can be reduced. As such, with the reduction of the reset period and the address period, the sustain period can be increased, thereby enhancing the power of a gray-scale representation.

Although exemplary embodiments of the present invention have been described in detail hereinabove, it should be understood that many variations and/or modifications of the basic inventive concept taught herein will still fall within the spirit and scope of the present invention, as defined by the appended claims.

What is claimed is:

1. A Plasma Display Panel (PDP), comprising:
a first substrate and a second substrate arranged to face each other with a space therebetween, the space between the first substrate and the second substrate being divided into a plurality of discharge cells;
phosphor layers arranged in the plurality of discharge cells;
first electrodes and second electrodes extending in a first direction between the first substrate and the second substrate and alternately disposed in parallel on both sides of respective discharge cells in a second direction intersecting the first direction and shared by adjacent discharge cells, the first electrodes and the second electrodes having floating portions extending toward the second substrate in a direction away from the first substrate and arranged to face one another in spaces corresponding to the respective discharge cells; and
address electrodes extending in the second direction between the first substrate and the second substrate, the address electrodes having protruding portions that protrude between the floating portions of the first electrodes and the floating portions of the second electrodes.

2. The PDP according to claim 1, further comprising:
a first barrier rib layer arranged adjacent to the first substrate to define a plurality of discharge spaces; and
a second barrier rib layer arranged adjacent to the second substrate to define discharge spaces facing the respective discharge spaces defined by the first barrier rib layer;
wherein the respective discharge cells are divided by pairs of discharge spaces facing each other.

3. The PDP according to claim 2, wherein the address electrodes, the first electrodes, and the second electrodes are arranged between the first barrier rib layer and the second barrier rib layer.

4. The PDP according to claim 2, wherein the protruding portions are plurally arranged along the second direction in the respective discharge cells.

5. The PDP according to claim 2, wherein the address electrodes, the protruding portions of the address electrodes, and the floating portions of the first electrodes and the second electrodes corresponding to the protruding portions are arranged adjacent to the first substrate;
wherein the first electrodes and the second electrodes are arranged adjacent to the second substrate; and
wherein the protruding portions of the address electrodes and the floating portions of the first electrodes and the second electrodes are arranged on a same line in a direction parallel to the planes of the substrates.

6. The PDP according to claim 5, wherein the protruding portions and the floating portions have the same thickness in a direction perpendicular to the planes of the substrates.

7. The PDP according to claim 2, wherein the address electrodes, the protruding portions of the address electrodes, and the floating portions of the first electrodes and the second electrodes corresponding to the protruding portions are arranged adjacent to the second substrate;
wherein the first electrodes and the second electrodes are arranged adjacent to the first substrate, and
wherein the protruding portions of the address electrodes and the floating portions of the first electrodes and the second electrodes are arranged on a same line in a direction parallel to the planes of the substrates.

8. The PDP according to claim 7, wherein the protruding portions and the floating portions have the same thickness in a direction perpendicular to the planes of the substrates.

9. The PDP according to claim 2, wherein a thickness of each of the address electrodes is less than a height of each of the first electrodes in a direction perpendicular to the planes of the substrates.

10. The PDP according to claim 2, wherein a thickness of each of the address electrodes is less than a height of each of the second electrodes in a direction perpendicular to the planes of the substrates.

11. The PDP according to claim 2, wherein a height of each of the first electrodes is greater than a thickness of each of the floating portions of the first electrodes in a direction perpendicular to the planes of the substrates.

12. The PDP according to claim 2, wherein a height of each of the second electrodes is greater than a thickness of each of the floating portions of the second electrodes in a direction perpendicular to the planes of the substrates.

13. The PDP according to claim 2, wherein the first electrodes and the second electrodes have structures in which a vertical length is greater than a horizontal length in a direction perpendicular to the planes of the substrates.

14. The PDP according to claim 2, wherein a horizontal length of each of the floating portions of the first electrodes and the second electrodes is greater than a horizontal length of each of the first electrodes and the second electrodes in a direction perpendicular to the planes of the substrates.

15. The PDP according to claim 2, wherein the first electrodes and the second electrodes comprise a metal.

16. The PDP according to claim 2, wherein the first electrodes, the second electrodes, and the address electrodes are covered with a dielectric layer to comprise an insulated structure.

17. The PDP according to claim 16, wherein the dielectric layer comprises a black dielectric material.

18. The PDP according to claim 16, wherein the dielectric layer comprises a black dielectric material layer arranged on the second substrate.

19. The PDP according to claim 16, wherein the dielectric layer is covered with a protective film.

20. The PDP according to claim 2, wherein the first barrier rib layer has first barrier rib members arranged in a direction parallel to the address electrodes and second barrier rib members arranged to intersect the first barrier rib members; and
wherein the second barrier rib layer has third barrier rib members arranged to correspond to the first barrier rib members and fourth barrier rib members arranged to intersect the third barrier rib members.

21. The PDP according to claim 1, wherein the phosphor layers comprise first phosphor layers arranged on the first substrate of the respective discharge cells and second phosphor layers arranged on the second substrate of the respective discharge cells.

22. The PDP according to claim 1, wherein the first electrodes that supply sustain pulses in a sustain period, the floating portions of the first electrodes, the second electrodes that supply the sustain pulses in the sustain period and supply scan pulses in a scan period, and the floating portions of the second electrodes are alternately arranged on both sides of the respective discharge cells in the second direction and shared by the adjacent discharge cells; and
wherein the first electrodes, the floating portions of the first electrodes, the second electrodes, and the floating portions of the second electrodes corresponding to adjacent discharge cells in the second direction are arranged in the same order.

23. A method of driving a Plasma Display Panel (PDP), comprising:
alternately arranging first electrodes and second electrodes in parallel on both sides of respective discharge cells of the PDP and shared by adjacent discharge cells;
arranging floating portions of the first electrodes, floating portions of the second electrodes, and first address electrodes and second address electrodes of the PDP to intersect the first electrodes and the second electrodes and to correspond to the respective discharge cells in parallel and arranging protruding portions between the floating portions;
supplying a scan pulse to at least a portion of the corresponding second electrode shared by adjacent discharge cells in an address period; and
addressing adjacent discharge cells, to which the scan pulse has been supplied in the address period.

24. The method of driving a PDP according to claim 23, wherein addressing adjacent discharge cells comprises addressing one of the adjacent discharge cells by the corresponding first address electrode.

25. The method of driving a PDP according to claim 24, wherein addressing adjacent discharge cells comprises addressing the other of the adjacent discharge cells by the corresponding second address electrode.

26. A Plasma Display Panel (PDP), comprising:
a first substrate and a second substrate arranged to face each other with a space therebetween, the space between the first substrate and the second substrate being divided into a plurality of discharge cells;
first electrodes and second electrodes extending in a first direction between the first substrate and the second substrate and alternately arranged in parallel on both sides of the respective discharge cells in a second direction intersecting the first direction and shared by adjacent discharge cells, the first electrodes and the second electrodes being divided into at least two portions in directions toward the first substrate and the second substrate to face each other in a space; and
first address electrodes and second address electrodes extending in the second direction between the first substrate and the second substrate, the first address electrodes and the second address electrodes having protruding portions alternately protruding inside the discharge cells arranged along the second direction.

27. The PDP according to claim 26, wherein the first address electrodes are arranged on the first substrate and the second address electrodes are arranged on the second substrate with the first electrodes and the second electrodes therebetween.

28. The PDP according to claim 26, wherein the first address electrodes and the second address electrodes are arranged on the same side of the discharge cells in the first direction.

29. The PDP according to claim 28, wherein the first address electrodes and the second address electrodes are respectively arranged on the first substrate and the second substrate.

30. The PDP according to claim 29, wherein the protruding portions of the first address electrodes and the protruding portions of the second address electrodes protrude toward centers of the respective discharge cells on the same side of the discharge cells.

31. The PDP according to claim 26, wherein the first address electrodes and the second address electrodes are arranged on both sides of the respective discharge cells in the first direction.

32. The PDP according to claim 31, wherein the protruding portions of the first address electrodes and the protruding portions of the second address electrodes protrude toward centers of the respective discharge cells on both sides of the respective discharge cells.

33. The PDP according to claim 26, wherein the first address electrodes and the second address electrodes comprise a metal.

34. The PDP according to claim 26, wherein the first electrodes and the second electrodes have floating portions separated in a direction perpendicular to planes of the substrates.

35. The PDP according to claim 26, wherein the first electrodes and the second electrodes have first floating portions separated on the first substrate to correspond to the discharge cells and second floating portions separated on the second substrate to correspond to the first floating portions.

36. The PDP according to claim 35, wherein the protruding portions of the first address electrodes are arranged between the first floating portions of the first electrodes and the second floating portions of the second electrodes; and
wherein the protruding portions of the second address electrodes are arranged between the second floating portions of the first electrodes and the second floating portions of the second electrodes.

37. The PDP according to claim 35, further comprising:
a first barrier rib layer arranged adjacent to the first substrate to define a plurality of discharge spaces; and
a second barrier rib layer arranged adjacent to the second substrate to define discharge spaces facing the respective discharge spaces defined by the first barrier rib layer;
wherein the respective discharge cells are divided by the pairs of discharge spaces facing each other;
wherein the first electrodes and the second electrodes are arranged between the first barrier rib layer and the second barrier rib layer;
wherein the first address electrodes, the protruding portions of the first address electrodes, and the first floating portions of the first electrodes and the second electrodes corresponding to the protruding portions are arranged adjacent to the first substrate; and
wherein the second address electrodes, the protruding portions of the second address electrodes, and the second floating portions of the first electrodes and the second electrodes corresponding to the protruding portions are arranged adjacent to the second substrate.

38. The PDP according to claim 37, wherein the protruding portions of the first address electrodes and the first floating portions of the first electrodes and the second electrodes corresponding to the protruding portions are arranged on a same line in a direction parallel to planes of the substrates; and
wherein the protruding portions of the second address electrodes and the second floating portions of the first electrodes and the second electrodes corresponding to the protruding portions are arranged on a same line in a direction parallel to the planes of the substrates.

39. The PDP according to claim 37, wherein the protruding portions of the first address electrodes and the first floating portions of the first electrodes and the second electrodes corresponding to the protruding portions have the same thickness in a direction perpendicular to planes of the substrates; and
wherein the protruding portions of the second address electrodes and the second floating portions of the first electrodes and the second electrodes corresponding to the protruding portions have the same thickness in a direction perpendicular to the planes of the substrates.

40. The PDP according to claim 26, wherein the first electrodes and the second electrodes comprise a metal.

41. The PDP according to claim 26, wherein the first electrodes, the second electrodes, the first address electrodes, and the second address electrodes are covered with a dielectric layer to comprise an insulated structure.

42. The PDP according to claim 41, wherein the dielectric layer has a protective film arranged on the outer surface thereof.

43. The PDP according to claim 37, wherein each discharge space defined by the second barrier rib layer has a volume greater than that of each discharge space defined by the first barrier rib layer.

44. A method of driving a Plasma Display Panel (PDP), comprising:
alternately arranging first electrodes and second electrodes of the PDP in parallel on both sides of respective discharge cells and shared by adjacent discharge cells and divided into at least two portions on both sides of respective discharge cells;
arranging floating portions of the first electrodes, and first address electrodes and second address electrodes of the PDP to intersect the first electrodes and the second electrodes and to correspond to the respective discharge cells in parallel and having protruding portions alternately protruding in the discharge cells arranged in the extended direction thereof:
supplying a scan pulse to at least a portion of the corresponding second electrode shared by adjacent discharge cells in an address period; and
addressing adjacent discharge cells, to which the scan pulse has been supplied in an address period.

45. The method of driving a PDP according to claim 44, wherein addressing adjacent discharge cells comprises addressing one of the adjacent discharge cells by the corresponding first address electrode.

46. The method of driving a PDP according to claim 45, wherein addressing adjacent discharge cells comprises addressing the other of the adjacent discharge cells by the corresponding second address electrode.
